(19) United States
(12) Patent Application Publication
(10) Pub. No.: US 2010/0057985 A1
(43) Pub. Date: Mar. 4, 2010

(54) SYSTEM AND METHOD FOR ALLOCATING PERFORMANCE TO DATA VOLUMES ON DATA STORAGE SYSTEMS AND CONTROLLING PERFORMANCE OF DATA VOLUMES

(75) Inventors: Yasunori Kaneda, San Jose, CA (US); Hidehisa Shitomi, Mountain View, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/199,758

(22) Filed: Aug. 27, 2008

(51) Int. Cl. G06F 12/08; G06F 12/06

(52) U.S. Cl. 711/114; 711/170; 711/E12.084; 711/E12.019

(57) ABSTRACT

System and method for dynamic chunk allocation to data volumes in storage systems. The system includes host computer, management computer and storage system. A dynamic chunk allocation program in the storage system allocates chunks from chunk pool to a volume using a chunk pool management table and a chunk table. A chunk allocation rule table holds rules for allocating chunks from the HDDs. The dynamic chunk allocation program refers to the chunk allocation rule table, to allocate a chunk to a volume. The storage system may have a chunk move program for moving a chunk from one HDD to another HDD or from parity group to parity group for load balancing. A host ID identifying program in the storage system is also used for load balancing. The chunk allocation rule table may be updated by the management computer or rule creation program for changing the rules.

### FIELD OF THE INVENTION

This invention generally relates to data storage systems and, in particular, to allocating performance to data volumes on data storage systems and controlling performance of data volumes.

### DESCRIPTION OF THE RELATED ART

To reduce waste of unused physical blocks in a data storage volume, dynamic chunk allocation capability has been developed for use in data storage systems. Just like conventional storage systems, the storage systems with the aforesaid dynamic chunk allocation capability also include data volumes. However, the data volumes initially do not have any physical storage blocks allocated to them. The storage system allocates a chunk from a chunk pool to the data volume when a write command directed to the data volume is received. Such allocated chunk includes one or more physical blocks.

For example, U.S. Patent Application Publication No. 20040162958 to Kano et al., incorporated herein by reference, titled “Automated on-line capacity expansion method for storage device” discloses a method for dynamic chunk allocation capability for a storage device. In this reference, the chunk is allocated when the storage device receives a write command.

As would be appreciated by those of ordinary skill in the art, performance of a data volume in a storage system, including data volumes with dynamic chunk allocation capability, is determined by a number of physical hard disk drives (HDDs), which provide physical blocks for use by the data volume. Specifically, the greater is the number of the HDDs associated with the data volume, the higher is the data throughput that can be handled by the corresponding data volume.

Unfortunately, the conventional chunk allocation methods fail to enable one to control the number of HDDs providing physical storage for data storage volumes. Accordingly, the conventional storage systems are also unable to control the performance of the data storage volumes allocated using a dynamic chunk allocation mechanism.

The U.S. Patent Application Publication No. 20040162958 to Kano, mentioned above, does not disclose a method or system for controlling the number of HDDs assigned to a volume. Other conventional storage systems have also failed to address this problem. Therefore, there is a need for systems and methods that dynamically allocate hard disk drives to data volumes and control the performance of the data volumes on data storage systems.

### SUMMARY OF THE INVENTION

The inventive concept is directed to methods and systems that substantially obviate one or more of the above and other problems associated with conventional techniques for allocating performance to data volumes and controlling performance of data volumes.

One aspect of the present invention is used for data storage apparatuses or systems for allocating and controlling performance to data volumes. In one aspect, the storage system has dynamic chunk allocation capability such that chunks are allocated from a chunk pool when a write command is received and if a chunk has not been allocated yet. Aspects of the invention make performance of volume with dynamic chunk allocation capability controllable. The storage system can provide volumes with various performance characteristics to host computers.

In accordance with one aspect of the inventive methodology, there is provided a computerized storage apparatus incorporating multiple storage devices, which provide multiple storage chunks forming a chunk pool; and a storage controller for dynamically allocating at least one of the multiple chunks from the chunk pool to a storage volume in response to an access command received by the computerized storage apparatus. The aforesaid access command is directed to the storage volume. The storage controller is further configured to control a performance of the storage volume by controlling a number of the multiple storage devices furnishing the at least one of the multiple chunks allocated to a storage volume in accordance with a predetermined rule associated with the storage volume.

In accordance with another aspect of the inventive methodology, there is provided a computer-implemented method performed in a storage system incorporating multiple storage devices, the storage devices providing multiple storage chunks forming a chunk pool; and a storage controller. The inventive method involves dynamically allocating at least one of the multiple chunks from the chunk pool to a storage volume in response to an access command received by the computerized storage apparatus, the access command being directed to the storage volume. In addition, the inventive method involves controlling a performance of the storage volume by controlling a number of the multiple storage devices furnishing the at least one of the multiple chunks allocated to a storage volume in accordance with a predetermined rule associated with the storage volume.

In accordance with another aspect of the inventive methodology, there is provided a computer-readable medium embodying a set of instructions, which, when executed by one or more processors, cause the one or more processors to perform a method in a storage system incorporating multiple storage devices, the storage devices providing multiple storage chunks forming a chunk pool; and a storage controller. The inventive method involves dynamically allocating at least one of the multiple chunks from the chunk pool to a storage volume in response to an access command received by the computerized storage apparatus, the access command being directed to the storage volume. In addition, the inventive method involves controlling a performance of the storage volume by controlling a number of the multiple storage devices furnishing the at least one of the multiple chunks allocated to a storage volume in accordance with a predetermined rule associated with the storage volume.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1(a) and FIG. 1(b) show an exemplary information system for implementing methods according to aspects of the present invention.

FIG. 2 shows an exemplary relationship between a write command, dynamic chunk allocation volume, chunk pool, chunks and HDDs, according to aspects of the present invention.

FIG. 3(a) and FIG. 3(b) show exemplary chunk pool management tables, according to aspects of the present invention.

FIG. 4(a) and FIG. 4(b) show exemplary chunk tables, according to aspects of the present invention.

FIG. 5(a), FIG. 5(b), FIG. 5(c), FIG. 5(d) and FIG. 5(e) show exemplary chunk allocation rule tables, according to aspects of the present invention.

FIG. 6(a) and FIG. 6(b) show exemplary HDD tables, according to aspects of the present invention.

FIG. 7 shows a flow chart of an exemplary write process, according to aspects of the present invention.

FIG. 8 shows a flow chart of an exemplary read process, according to aspects of the present invention.

FIG. 9(a) and FIG. 9(b) show exemplary access frequencies of the chunk move program at each chunk, according to aspects of the present invention.

FIG. 10 shows an exemplary grouping of the HDDs in a storage apparatus, according to aspects of the present invention.

FIG. 11 shows a group table showing an exemplary grouping of the HDDs, according to aspects of the present invention.

FIG. 12 shows exemplary chunks in a RAID group when an HDD is replaced by a RAID group, according to aspects of the present invention.

FIG. 13 shows an exemplary simultaneous access by two host computers to one volume, according to aspects of the invention.

FIG. 14 shows a flow chart for an exemplary DCAV provisioning process, according to aspects of the invention.

FIG. 15 shows an exemplary volume rule mapping table to be used with a DCAV provisioning process, according to aspects of the invention.

FIG. 16(a) and FIG. 16(b) show an exemplary information system for implementing methods according to aspects of the present invention.

FIG. 17 shows an exemplary classification or class table, according to aspects of the present invention.

FIG. 18 shows an exemplary file apparatus provisioning menu table, according to aspects of the present invention.

FIG. 19 shows a flowchart for an exemplary DCAV provisioning process, according to aspects of the present invention.

FIG. 20 shows a flowchart for an exemplary process of responding to an indication of change in the number of HDDs, according to aspects of the present invention.

FIG. 21 shows an exemplary volume menu mapping table, according to aspects of the present invention.

FIG. 22 shows an exemplary expanding method management table, according to aspects of the present invention.

FIG. 23 shows an exemplary virtual machine configuration, according to aspects of the invention.

FIG. 24 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

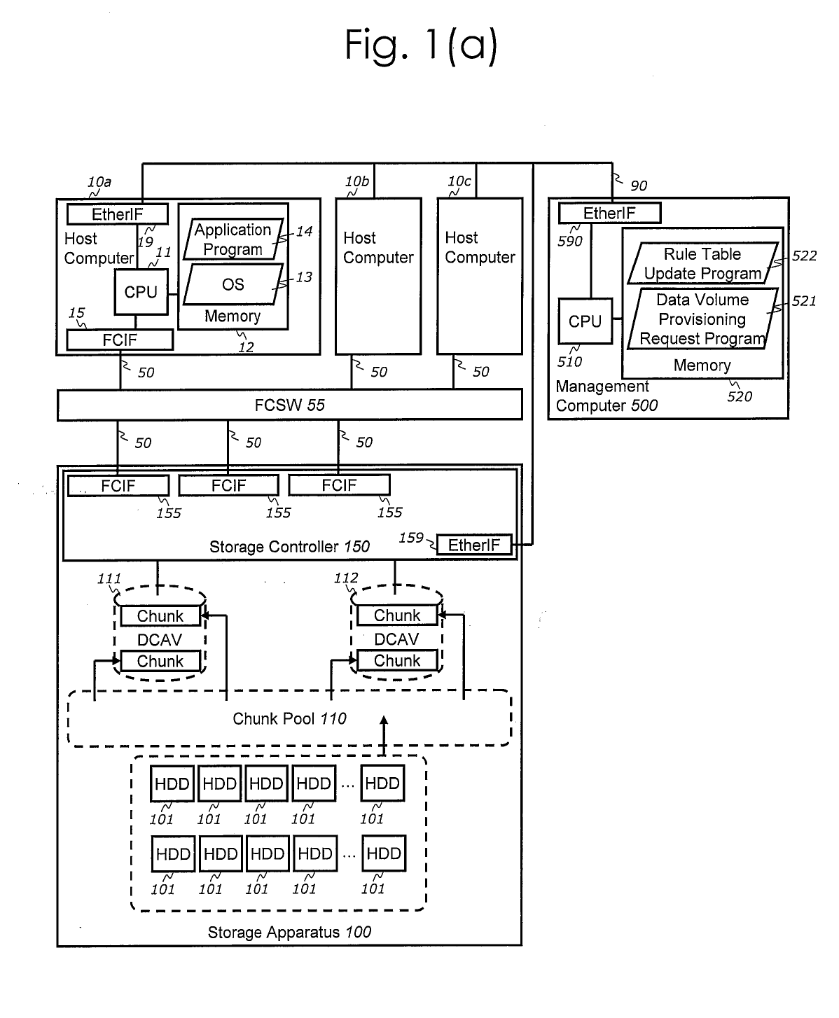

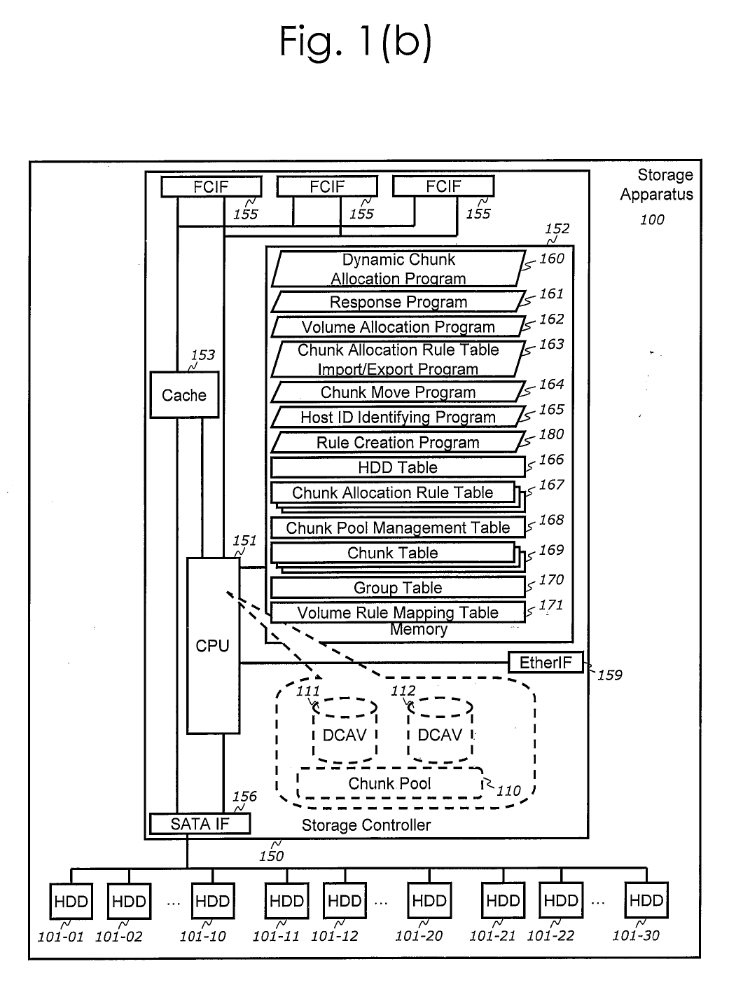

FIG. 1(a) and FIG. 1(b) illustrate an exemplary information system upon which one or more aspects of the inventive methodology may be implemented. The exemplary information system shown in the aforesaid figures includes one or more host computers 10a, 10b and 10c, a storage apparatus 100, a management computer 500, a data network 50 for coupling the storage apparatus to the host computers, and a management network 90 for coupling the host-computers 10a, 10b, 10c and storage 100 to the management computer 500.

In an embodiment of the invention, at least one host computer 10a, 10b or 10c is coupled to the storage apparatus 100 via the data network 50. In the specifically shown embodiment, three host computers 10a, 10b and 10c are coupled together. The host computers 10a, 10b and 10c may execute at least one operating system (OS) 13. It should be noted that the present invention is not limited to any specific operating system and that any suitable OS, including, without limitation, Unix, Linux, Solaris or Microsoft Windows, may be utilized in the host computers 10a, 10b and/or 10c.

In addition, an application program 14 may be executed by the respective host computer 10a, 10b or 10c under the control of the OS 13. Files and data for the OS 13 and the application program 14 are stored in data volumes 111 and 112, which are provided to the host computers by the storage apparatus 100. The OS 13 and the application program 14 may issue write and/or read commands to the storage apparatus 100 in order to read or write the corresponding data stored in the data volumes 111 and 112.

In an embodiment of the invention, at least one storage apparatus 100 is implemented using a storage controller 150 and one or more HDDs 101. The storage apparatus 100 incorporates one or more chunk pools 110, which includes one or more HDDs 101. The storage apparatus 100 provides one or more data storage volumes to the host computers 10a, 10b and/or 10c. In the embodiment shown in FIG. 1(b), the storage controller 150 of the storage apparatus 100 incorporates a dynamic chunk allocation program 160. This program facilitates the creation of data storage volumes as dynamic chunk allocation volumes (DCAV) 111 and/or 112.

In the embodiment of the inventive system shown in FIG. 1(a), at least one management computer 500 is coupled the storage apparatus 100 and at least one of the host computers 10a, 10b and/or 10c via the management network 90.

At least some of the host computers 10a, 10b and/or 10c and the storage apparatus 100 are coupled together via the data network 50. The data network 50 in the shown embodiment is implemented using a Fibre Channel protocol. However, as would be appreciated by those of skill in the art, other networks, such as Ethernet and Infiniband can be used for this purpose as well. A network switch and a hub can be used for coupling the network components to one another. For example, in the embodiment shown in FIG. 1(a), a Fibre Channel Switch (FCSW) 55 is used for coupling the components to each other. In this exemplary configuration, the host computers 10a, 10b and/or 10c and the storage apparatus 100 have one or more Fibre Channel interface boards (FCIF) 155 for coupling to the Fibre Channel data network 50.

In an embodiment of the inventive system, the host computers 10a, 10b and/or 10c and the storage apparatus 100 are coupled to the management computer 500 via the management network 90. The management network 90 in the shown embodiment is implemented using Ethernet protocol. However, other suitable types of network protocols and interconnects can be used for this purpose as well. As well known to persons of skill in the art, network switches and hubs can be used for coupling the various network components to one another. In the illustrated embodiment of the inventive system, the host computers 10a, 10b and 10c, the storage apparatus 100 and the management computer 500 may incorporate one or more Ethernet interface boards (EtherIF) 159 for coupling to the Ethernet management network 90.

In an embodiment of the inventive system, the host computer 10a incorporates a memory 12 for storing the programs and data, a CPU 11 for executing programs stored in the memory 12, a FCIF 155 for coupling to the data network 50, and an EtherIF 15 for coupling the host computer 10a to the management network 90.

In the shown embodiment, the memory 12 stores the operating system program (OS) 13 and the application program 14. As stated above, the CPU 11 executes at least these two programs 13 and 14, but may also execute a wide variety of other applications. In various embodiments of the invention, the application program 14 may be a database management application, a GUI application, or any other type of software program. The present invention is not limited to the type of the application 14.

In the illustrated exemplary embodiment of the inventive concept (see FIG. 1(a)), the management computer 500 incorporates a memory 520 for storing the programs and data, a CPU 510 for executing programs stored in the memory 520, and an EtherIF 590 for coupling the management computer 500 to the management network 90.

In the shown embodiment of the inventive concept, the memory 520 of the management computer 500 stores a data volume provisioning request program 521 for issuing a data volume provisioning request to the storage apparatus 100 and a rule table update program 522 for updating chunk allocation rule tables stored in the memory 152 of the storage apparatus 100. The CPU 510 of the management computer 500 executes at least these two programs, but may execute other software applications of management or other nature as well.

The storage apparatus 100 shown in FIG. 1(b) incorporates one or more HDDs 101-01 through 101-30 for storing data, as well as one or more storage controllers 150 for providing data volumes to the host computers 10a-10c.

In an embodiment of the invention, each storage controller 150 includes the memory 152 for storing programs and data, a CPU 151 for executing the programs stored in the memory 152, a FCIF 155 for coupling the storage controller 150 to the data network 50, a SATA IF 156 for coupling the storage controller 150 to the HDD 101, a cache 153 for storing data received from the host computer or read from the HDDs, and an EtherIF 159 for coupling the storage controller 150 to the management network 90. In the shown embodiment, the HDDs are implemented using the widely used SATA interface. However, if the HDDs within the storage apparatus 100 use another type of data transfer interface, such as SCSI or ATA, the storage controller would implement an appropriately matched interface, in place of the SATA interface 156, which would support the corresponding protocol of the used HDDs.

In the embodiment of the system shown in FIG. 1(b), the CPU 151 of the storage controller 150 executes at least seven programs, which are stored in the aforesaid memory 152. In the shown embodiment, the memory 152 stores a dynamic chunk allocation program 160 for allocating a chunk to data storage volumes when a write request is received and no chunk is yet allocated, a response program 161 for responding to the at least READ or CAPACITY/READ/WRITE commands from the host computer 10, a volume allocation program 162 for creating a dynamic chunk allocation volume and allocating it to the host computer 10, a chunk allocation rule table import/export program 163 for importing and exporting the chunk allocation rule table to from or to the storage controller 150, a chunk move program 164 for moving a chunk from one HDD to another HDD for expanding or reducing the number of HDDs in a volume according to the rule, a host ID identifying program 165 for identifying ID of the host computers and, finally, a rule creation program 180 for creating the chunk allocation rule table from the chunk table for controlling the chunk allocation. In the shown embodiment, the host ID is World Wide Name (WWN) of the corresponding FC interface.

The memory 152 of the storage controller 150 may also store a number of tables including an HDD table 166, a chunk allocation rule table 167, a chunk pool management table 168, a chunk table 169, a group table 170 and a volume mapping table 171.

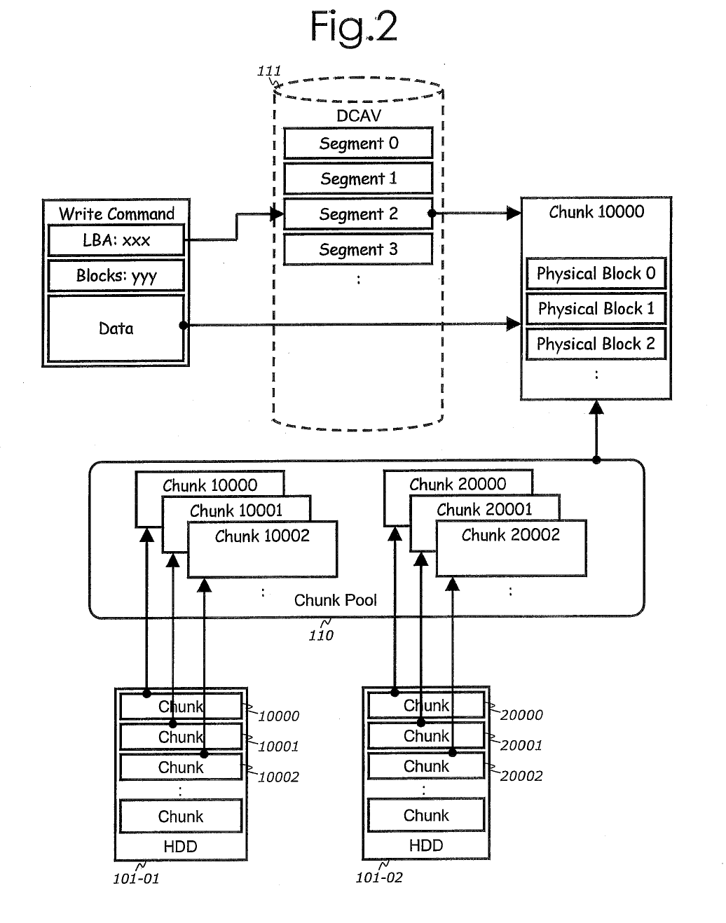

FIG. 2 illustrates an exemplary relationship between a write command, a dynamic chunk allocation volume, a chunk pool, as well as chunks and HDDs, according to various aspects of the present invention.

Initially, the dynamic chunk allocation volumes (DCAV) 111 and/or 112 of FIG. 1(b) have no data blocks allocated to them. FIG. 2 shows the exemplary relationship between the write command, the DCAV 111, the chunk pool 110, the chunks and the HDDs. The volume 111 in this example has an exemplary storage capacity of 10000 GB. However, no data blocks are allocated when the DCAV 111 is first created; only the overall size of the volume is set. The data blocks are allocated to the volume 111 when the volume 111 receives a write command with data from one of the host computers. In this embodiment, upon the receipt of a write command by the volume 111, a chunk is allocated to the volume 111. The aforesaid chunk is a collection of physical data blocks from the HDDs 101. In the shown embodiment of the invention, the DCAV 111 is divided into a number of segments as shown in FIG. 2. In this embodiment, the size of each segment is the same as the size of the corresponding chunk.

In FIG. 2, each HDD 101-01 is shown as having a number of chunks 10000, 10001, 10002. The chunks of each HDD are pooled into the chunk pool 110. Each chunk 10000 includes a number of physical data blocks, physical block 0, physical block 1, physical block 2 in the HDDs 101. The physical blocks are not shown in FIG. 2. In the shown exemplary embodiment, a chunk is composed from blocks on a single HDD. Each chunk has a unique ID for identifying the chunk. Unused chunks are managed in the chunk pool 110. In the shown exemplary embodiment, the chunk pool 110 is managed by the chunk pool management table 168 stored in the memory 152 of the storage apparatus 100. In the exemplary embodiment shown, the storage apparatus 100 has one chunk pool 110. Thus, the storage apparatus 100 has one corresponding chunk pool management table 168. However, as would be appreciated by persons of skill in the art, any number of chunk pools can be used.

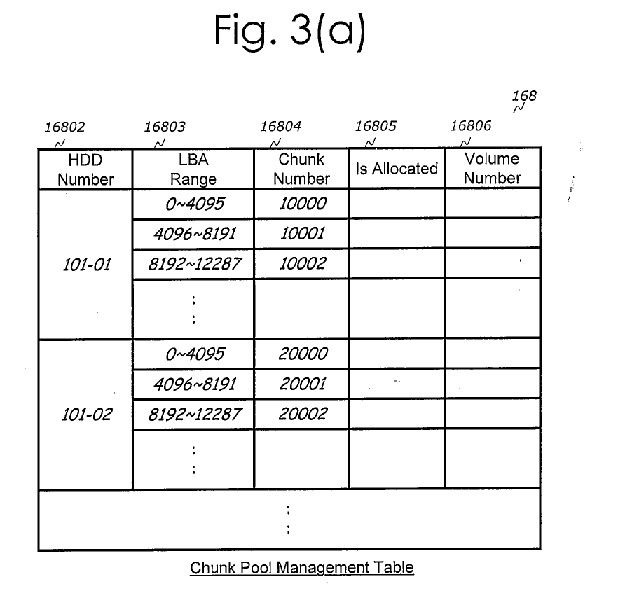

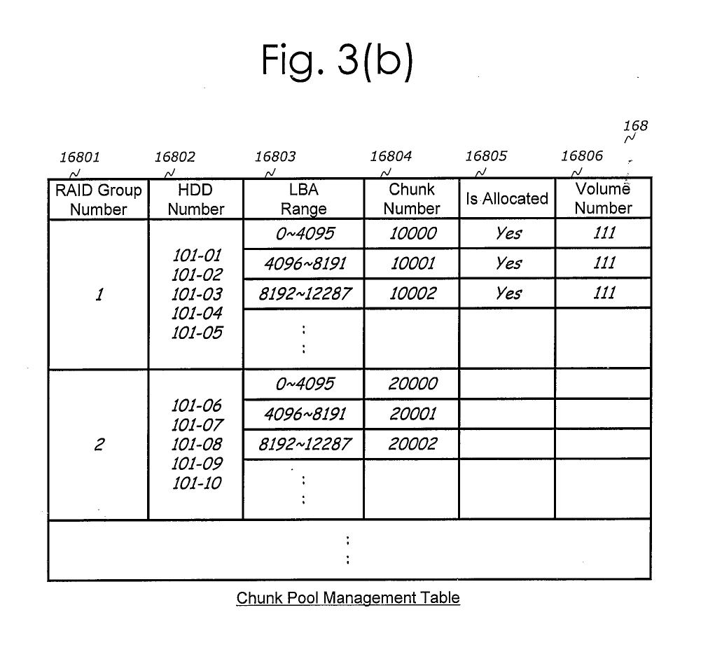

FIG. 3(a) and FIG. 3(b) illustrate exemplary chunk pool management tables, according to various aspects of the present invention. FIG. 3(b) shows a version of the chunk pool management table corresponding to the version of the table shown in FIG. 3(a), but when the HDDs are arranged in a RAID configuration. To this end, the chunk pool management table 168 of FIG. 3(b) includes a RAID Group Number column 16801 for storing RAID group numbers in the case that a RAID configuration is used for the HDDs, an “HDD Number” column 16802 for storing the HDD number, an “LBA Range” column 16803 for storing a logical block address (LBA) range corresponding to a chunk, a “Chunk Number” column 16804 for storing a chunk number for identifying the chunk, an “Is Allocated” column 16805 for storing a status whether the chunk has been allocated to a volume or not and a “Volume Number” column 16806 for storing a volume number of the DCAV whose segments have been allocated to the chunk in column 16804. The “RAID Group Number” is only used for RAID configuration. If no RAID is present, the table in FIG. 3(a) is used.

As stated above, no chunk is allocated to the DCAV initially. Therefore, all records in the column 16805 and the column 16806 are initially set to NULL.

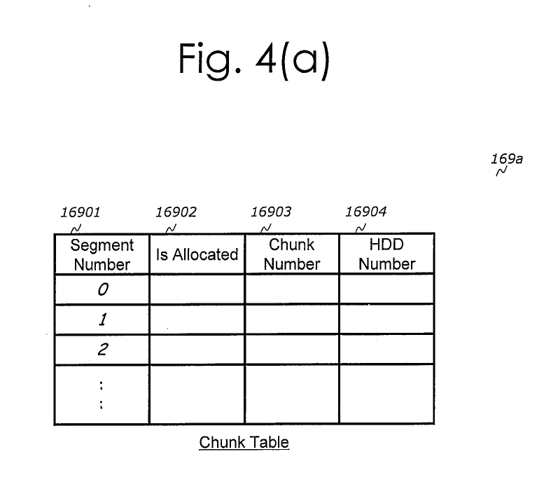

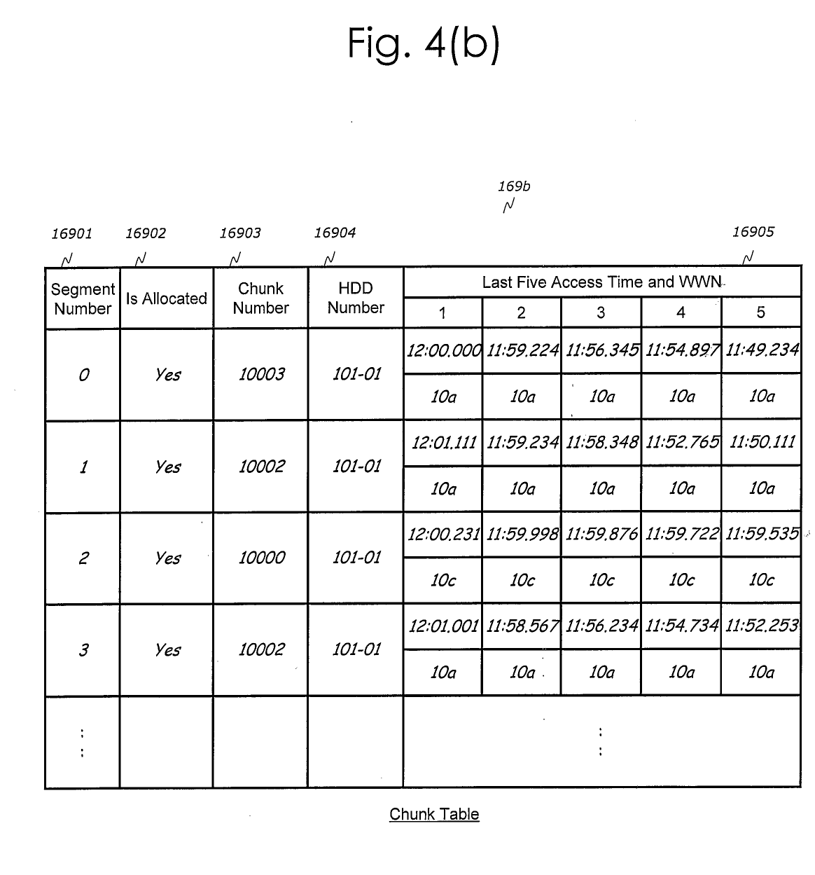

FIG. 4(a) and FIG. 4(b) show exemplary chunk tables 169, according to aspects of the present invention. The chunk table 169 is used for assigning chunks of the HDDs 101 to the segments of the DCAV 111. The reference numeral 169 is used where common features of 169a and 169b, respectively pertaining to FIG. 4(a) and FIG. 4(b) are addressed. The chunk table 169a and 169b both include a “Segment Number” column 16901 for storing a segment number for identifying the segment on the DCAV, an “Is Allocated” column 16902 for storing an allocation status of a chunk and determining whether a chunk has been allocated to a DCAV or not, a “Chunk Number” column 16903 for storing a chunk number allocated to the segment, and a “HDD Number” column 16904 for storing a HDD number where the chunk is located. Table 169b of FIG. 4(b) additionally includes a “Last Five Access Time and WWN” column 16905 for storing access times and WWNs of the chunk. This last column 16905 in table 169b in turn has five columns of its own where the latest five access times and WWNs are stored.

As stated above, no chunk is allocated to the DCAV initially. Therefore, all records in the column 16902, the column 16903 and the column 16904 are initially set to NULL. The storage controller 150 is able to determine the number of HDDs, which provide the chunks to the DCAV by checking the column 16904.

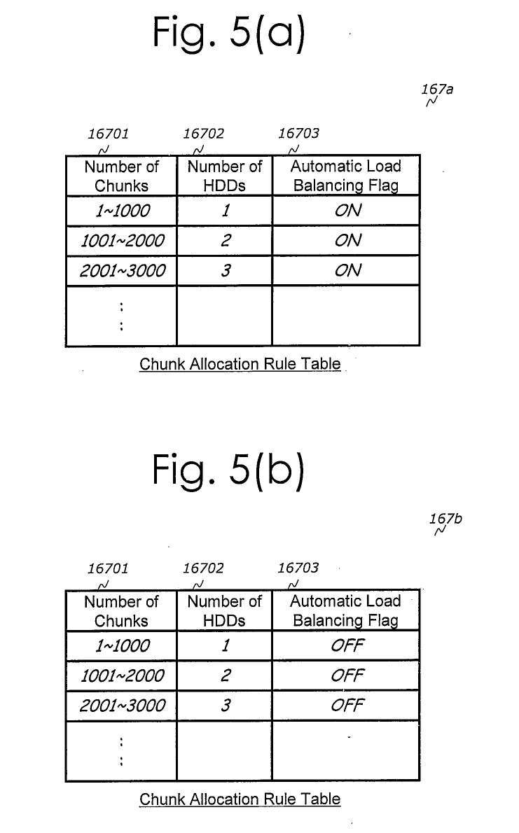

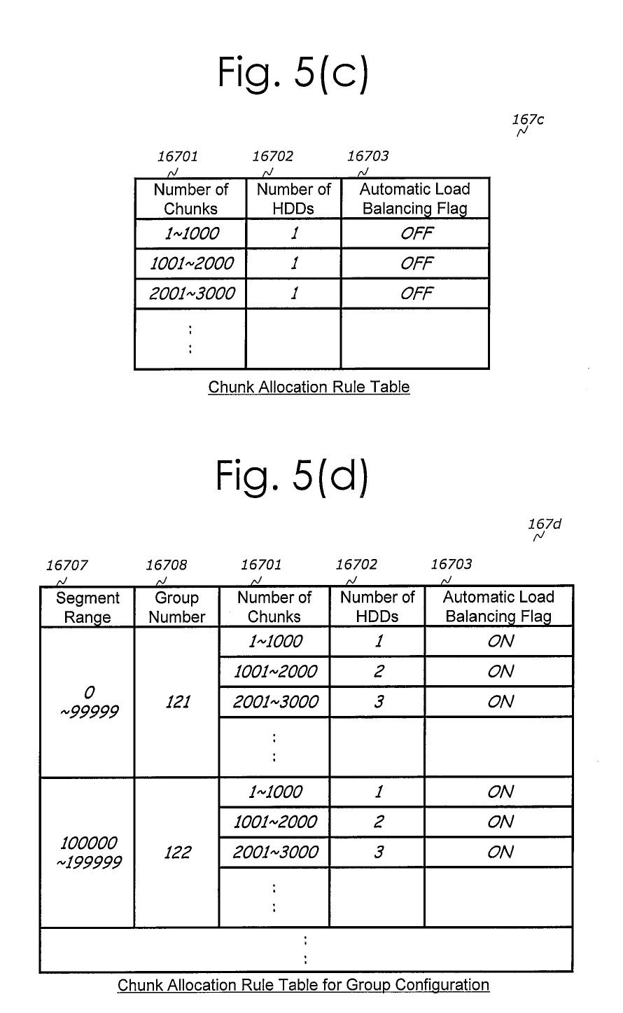

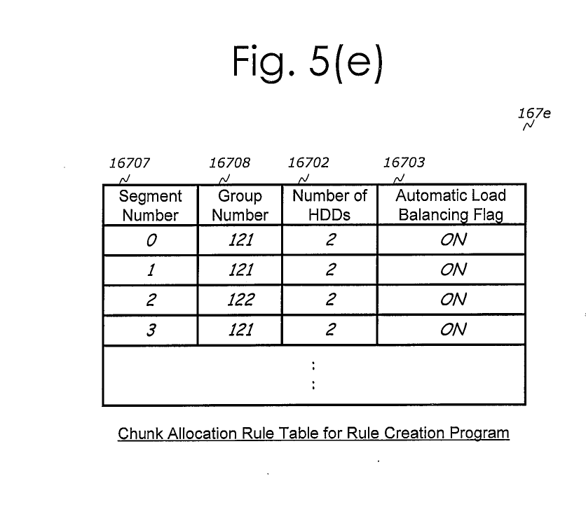

FIG. 5(a), FIG. 5(b), FIG. 5(c), FIG. 5(d) and FIG. 5(e) show exemplary embodiments of chunk allocation rule tables 167a-167e, according to various aspects of the present invention. Each table corresponds to a different chunk allocation rule that may be used in an inventive storage system. Such rule determines how different chunks and different HDDs are allocated to a storage volume.

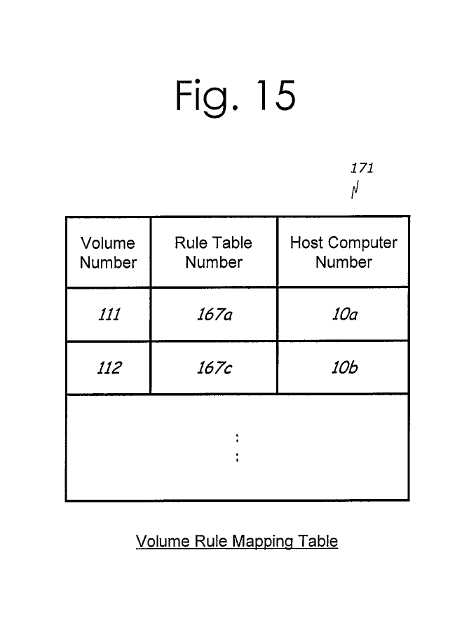

Each DCAV has a corresponding chunk allocation rule table 167 associated with it. Five different exemplary types of chunk allocation rule tables 167a, 167b, 167c, 167d and 167e are shown in the aforesaid FIG. 5(a), FIG. 5(b), FIG. 5(c), FIG. 5(d) and FIG. 5(e). The volume rule mapping table 171, shown in FIG. 15, may be used to determine which chunk allocation rule table 167a, 167b, 167c, 167d or 167e should be used for each specific DCAV 111 and 112.

In an embodiment of the invention, the chunk allocation rule table 167, which contains information controlling allocation of chunks to storage volumes, includes a “Number of Chunks” column 16701 for storing information on a numerical range (number) of allocated chunks to the DCAV, a “Number of HDDs” column 16702 for storing information on the number of the HDDs that are required to provide the number of allocated chunks in column 16701 and an “Automatic Load Balancing Flag” column 16703 for storing flags which indicate whether or not an automatic load balancing is enabled. In an embodiment of the invention, when the flag in column 16703 is “ON” and the “number of HDDs” in column 16702 is not the same as the number of the currently allocated HDDs, then the dynamic chunk allocation program 160 performs automatic load balancing. For example, in FIG. 5(a), if between one chunk and 1000 chunks are allocated to any given volume, then one HDD would be sufficient for providing all of the chunks. However, between 1001 and 2000 chunks are allocated to the volume, then an additional HDD for a total of 2 HDDs must be used to furnish all the required chunks.

Several exemplary embodiments of chunk allocation rule tables 167a, 167b, 167c, 167d and 167e are shown in FIG. 5(a) through FIG. 5(e). Each table corresponds to a different chunk allocation rule that may be used in an inventive storage system.

The chunk allocation rule table 167a, shown in FIG. 5(a), is designed for increasing performance of the storage volume when the number of the allocated chunks increases. Specifically, when less then 1000 chunks are allocated to a storage volume, only one HDD is used. On the other hand, for each 1000 additional allocated chunks, the number of allocated HDDs is proportionally increased. When the rule calls for a change in the number of the allocated HDDs (when the number of allocated chunks exceeds 1000, 2000, 3000, etc. marks), load balancing is executed. This is performed when the number of HDDs in use increases in relation to the current number of used HDDs. The load balancing distributes the allocated chunks in use substantially evenly among the allocated number of HDDs.

The chunk allocation rule table 167b, shown in FIG. 5(b), is also designed for increasing performance when the number of allocated chunks increases. However, in this case because Automatic Load Balancing Flag is OFF, load balancing is not executed when the number of the allocated chunks crosses the corresponding thresholds and the number of the allocated HDDs increases.

The chunk allocation rule table 167c, shown in FIG. 5(c), has the Automatic Load Balancing Flag set to OFF and does not provide for the increase of performance when the number of allocated chunks increases. In this case, the number of HDDs assigned to the volume is not increased when the number of chunks required by the volume increases and, consequently, the load balancing is not executed when the number of chunks increases.

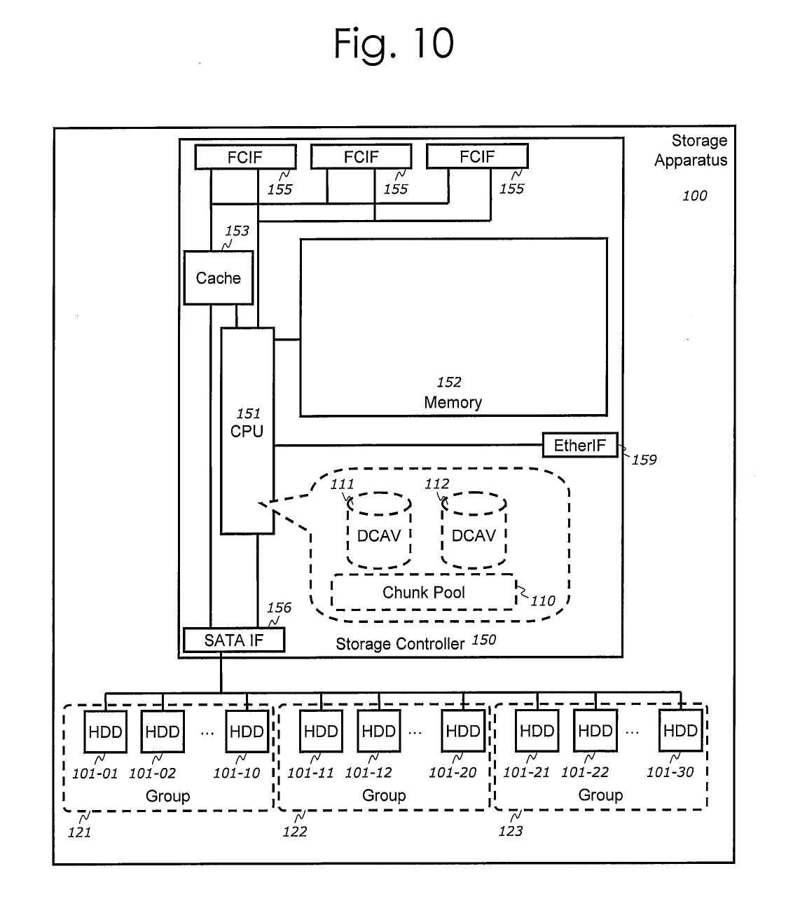

One exemplary embodiment of the chunk allocation rule table 167d, shown in FIG. 5(d), is a chunk allocation rule table for group configuration (as illustrated in FIG. 10). This table is used when the HDDs are grouped into HDD groups 121, 122 and 123, as shown in FIG. 10. The table of FIG. 5(d) also includes a “Segment Range” column 16707 for storing the segment numbers and a “Group Number” column 16708 for storing group number information. The “Segment Range” and the “Group Number” columns are used for group configuration. The segments on a DCAV are shown in ranges and each range of segments corresponds to a group of HDDs. In each group of HDDs, for example in group 121, one or more of the HDDs in the group may need to be used to satisfy the number of chunks required for the segments of the DCAV.

Another exemplary embodiment of the chunk allocation rule table 167e, shown in FIG. 5(e), is a chunk allocation rule table designed for the use by the rule creation program 180. The table of FIG. 5(e) includes a “Segment Number” column 16707e instead of the “Segment Range” column 16707 of FIG. 5(d). The “Segment number” is used by the rule creation program 180.

In an embodiment of the invention, the chunk allocation rule table import/export program 163 is provided to import or export the chunk allocation rule table from or to the management computer 500. This enables administrators for the computer system to change the chunk allocation rule table 163 on demand. In the case of exporting the chunk allocation rule table, the volume number of the DCAV, corresponding to the particular chunk allocation rule table, is specified by the rule table update program 522 for retrieving the chunk allocation rule table. In the case of import, the volume number of the DCAV is specified by the rule table update program 522 for updating the chunk allocation rule table.

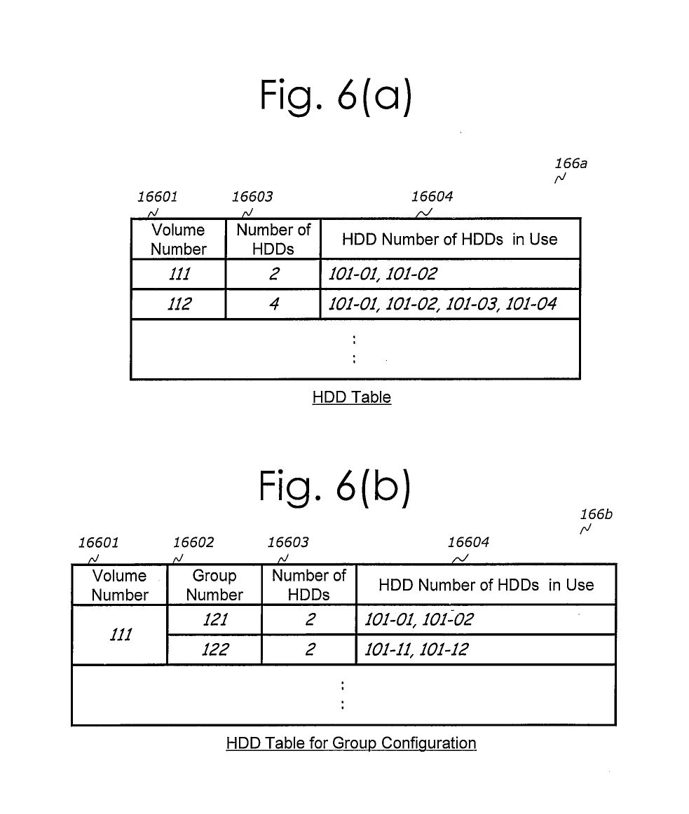

FIG. 6(a) and FIG. 6(b) illustrate exemplary embodiments of HDD tables, according to aspects of the present invention. FIG. 6(a) illustrates the HDD table 166a for storing the number of HDDs that are providing chunks to a particular DCAV. The HDD table 166a includes a “Volume Number” column 16601 for storing information on volume number of the DCAV 111 and 112, a “Number of HDDs” column 16603, which shows how many HDDs are now providing chunks to each volume and a “HDD Number of the HDDs in Use” column 16604 for storing HDD numbers identifying the HDDs which are providing chunks to the DCAV.

FIG. 6(b) shows a HDD table 166b for group configuration that additionally includes a “Group Number” column 16602 for storing group number of the HDDs in the case that the HDDs are grouped into groups of HDD as shown in FIG. 10.

A HDD with no allocated chunk to the volumes is spun-down to reduce electric power consumption. The dynamic chunk allocation program 160 spins-up the HDD before allocating chunks from the HDD to a DCAV. It may take tens of seconds for spinning-up a HDD. The dynamic chunk allocation program 160 may spin-up when number of remaining chunks on another HDD dips below a predetermined threshold.

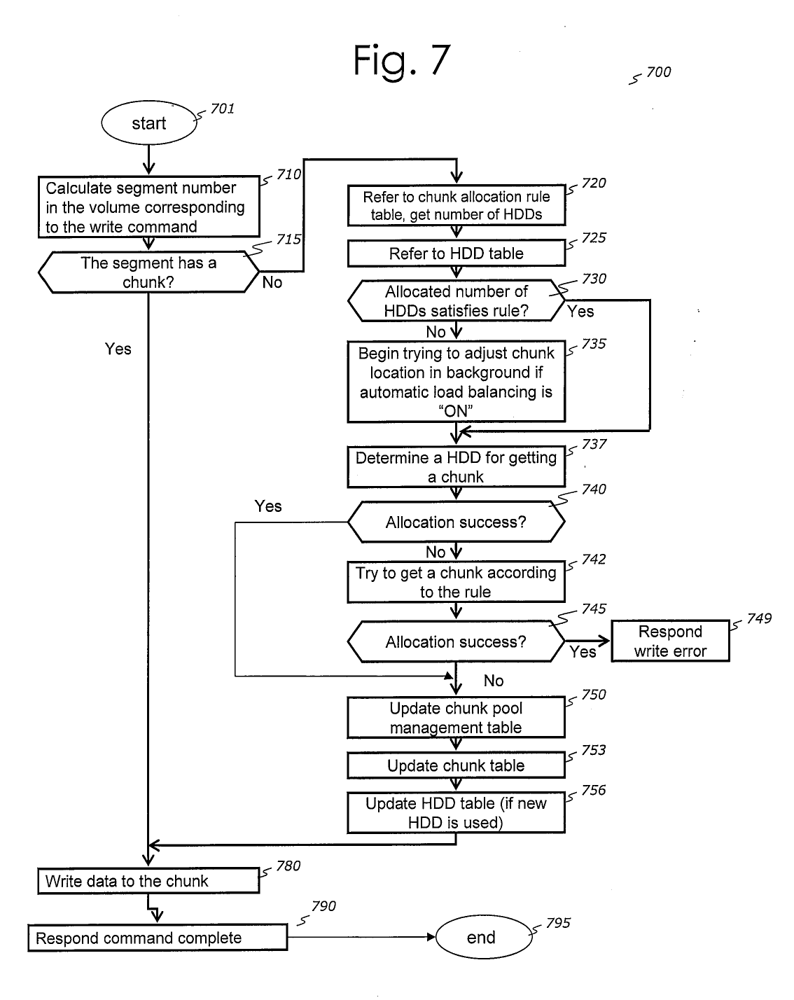

FIG. 7 shows a flow chart of an exemplary write process, according to aspects of the present invention. FIG. 7 shows the process flow in the response program 161 and the dynamic chunk allocation program 160.

The write process begins at 701. At 710, the process calculates segment number(s) in the volume corresponding to the write command. At 715, the process checks if the segment(s) has a chunk allocated to it already. If the segment(s) has a chunk, the process proceeds to step 780 where data is written to the allocated chunk and the process moves toward completions at 790 and 795.

However, if the segment or segments present in the volume do not have any chunks of the HDDs allocated to them, the process moves to 720. At 720, the process refers to the appropriate one of the chunk allocation rule tables 167a, 167b, 167c, 167d, 167e to obtain the number of HDDs that need to be used for the particular segment of the DCAV depending on the number of chunks that the DCAV requires. Each DCAV has a chunk allocation rule table assigned to the DCAV. The DCAV refers to the chunk allocation rule table 171 shown in FIG. 15 to fine the rule table assigned to it. The number of HDDs in the rule shows how many HDDs should be used for chunk provision to the volume. At 725, the process refers the HDD table 166a or 166b to determine which ones of the HDDs to use. The number of HDDs in the HDD table shows how many HDDs and which HDDs are currently being used for the volume 111, 112. At 730, the process determines if the allocated number of HDDs in the HDD table satisfies the number of HDDs required by the rule. If the number of HDDs allocated to the DCAV is equal to or smaller than the number of HDDs required by the rule, the process proceeds to 737.

However, if the allocated number of HDDs determined from the HDD table 166a, 166b is not the same as the number of HDDs listed in the rule table, the process moves to 735. At 735, the process, running in the background, begins trying to adjust chunk locations in the case of automatic load balancing being ON. In other words, the dynamic chunk allocation program 160 asks adjustment of the assignment of the chunks to the volumes from the chunk move program 164. At 737, the process determines a HDD for providing the chunk. At 740, the process checks whether chunk allocation was successful or not. If the chunk allocation fails, the process proceeds to 742. If the chunk allocation is successful, the process proceeds to 750.

When chunk allocation is determined to have failed at 740, the process moves to 742. At 742, the process attempts to get a chunk according to the rule provided by the chunk allocation rule table. At 745, the process checks to determine whether chunk allocation was successful. If the chunk allocation has failed, the process proceeds to 749. If the chunk allocation has succeeded, the process proceeds to 750.

When chunk allocation fails, the process responds to the write request with a write error at 749.

When chunk allocation succeeds, at 750, the process updates the chunk pool management table 168 and proceeds to 753. At 753, the process updates the chunk table 169. At 756, the process updates the HDD table 166a, 166b if a new HDD had to be used at 737. At 780, the process writes data to the chunk allocated to the segment of the DCAV. Finally, at 790, the process returns a response that the command is complete. At 795, the process ends

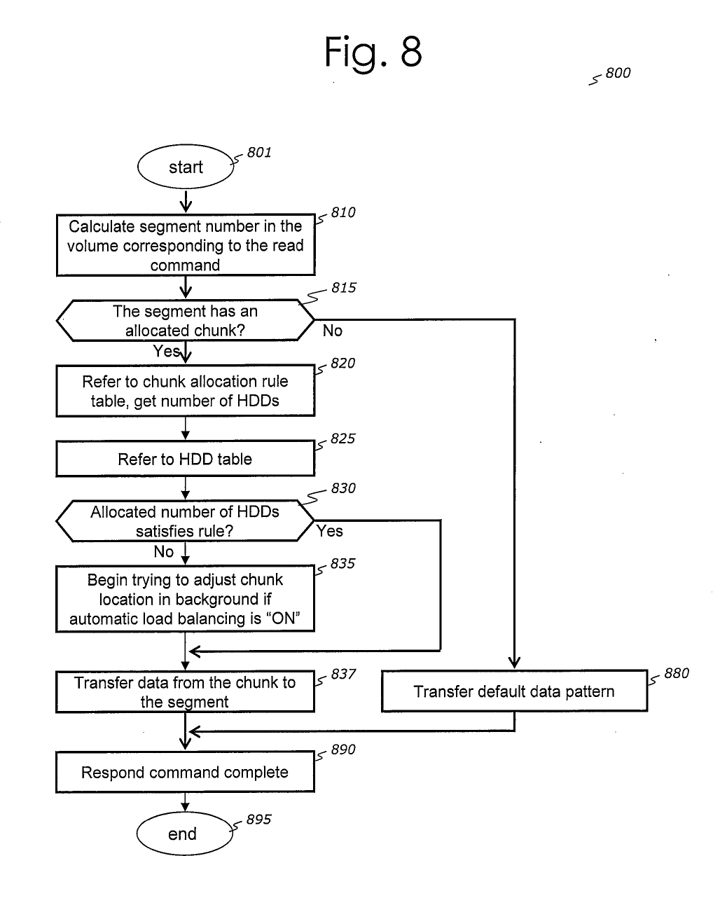

FIG. 8 shows a flow chart of an exemplary read process 800, according to aspects of the present invention. FIG. 8 shows the process flow in the response program 161 when a read request is received at the storage apparatus 100.

At step 810, the read process determines segment number(s) in the volume corresponding to the read command. At 815, the process checks to determine whether the segment segments determined at 810 have a chunk allocated to them already. If the segment has an allocated chunk, the process proceeds to 820. If the segment has no chunk allocated, the process proceeds to 880. At 880, a default data pattern is transferred to the segment and provided in response to the read request. The process then returns a complete message at 890 and ends at 895.

At 820, the process refers to the appropriate one of the chunk allocation rule tables 167a, 167b, 167c, 167d, 167e and obtains the number of HDDs allocated to the segment of the DCAV. The number of HDDs in the rule table shows how many HDDs can be used for the volume. At 825, the process refers to the HDD table 166a, 166b. The number of HDDs in the HDD table shows how many HDDs are currently being used for each volume.

At 830, the process determines whether the allocated number of HDDs in the HDD table satisfies the chunk allocation rule found in the chunk allocation rule table. If the number of HDDs currently allocated to a DCAV satisfies the rule, namely the number of allocated HDDs is the same as or larger than the number required by the rule, the process proceed to step 837.

If the number of currently allocated HDDs to the DCAV does not satisfy the chunk allocation rule, the process moves to 835. At 835, if the automatic load balancing option is ON, the process begins to adjust the chunk locations by running in the background. At this stage, the dynamic chunk allocation program 160 asks adjustment of the chunks from the chunk move program 164 when automatic load balancing is ON.

At 837, the process transfers data to be read from the chunk allocated to the segment. At 890, the process responds with a command complete message indicating that the read command has been completed. At 895, the process ends.

Adjustment of the chunk location is described below. The chunk move program 164 can adjust the chunk location. The chunk move program 164 begins trying to adjust the chunk location according to a request from the dynamic chunk allocation program 160. Adjusting the chunk location pertains to steps 735 and 835 of FIG. 7 and FIG. 8, respectively. The chunk move program 164 can move data from one chunk to another free chunk and update the chunk table 169 and the appropriate chunk pool management table 168a, 168b. For moving data from a chunk, the response program 161 suspends read/write access to the chunk.

In the case of the number of allocated HDDs being greater than the number required by the rule, the chunk move program 164 tries to move chunks out of the chunk pool 110 to reduce the number of allocated HDDs to a particular segment. As a result of, some HDDs will include no chunks that have been allocated to the volumes. The HDDs not including any allocated chunks may then be spun-down for reducing electric power consumption.

In the case of the number of allocated HDDs being fewer than the number required by the rule, the chunk move program 164 tries to move chunks to another chunk in the chunk pool 110 to increase the number of allocated HDDs to a DCAV.

The chunk move program 164 determines a chunk, which moves from a current HDD to another HDD, according to access frequency of the chunk. The chunk move program 164 may gather access frequency at each chunk.

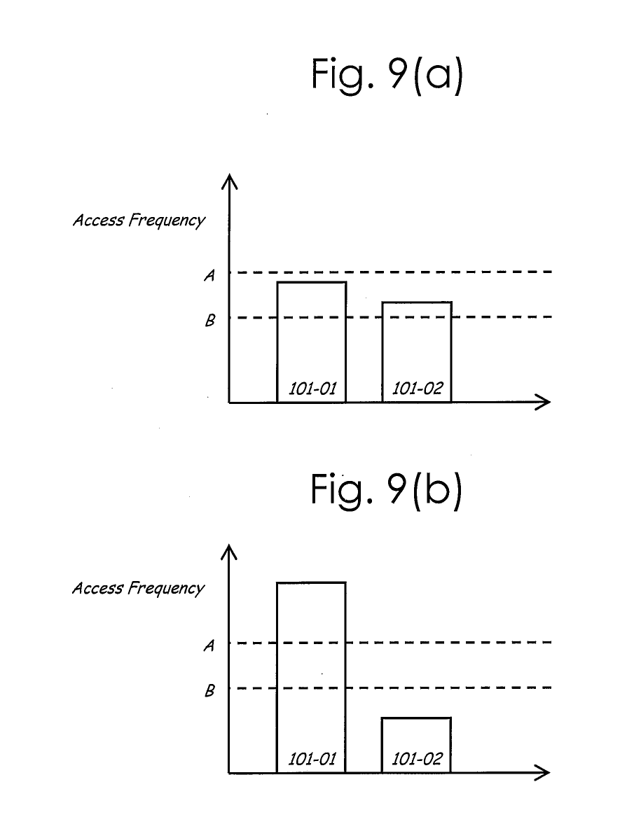

FIG. 9(a) and FIG. 9(b) show exemplary access frequencies of the chunk move program at each chunk, according to aspects of the present invention. Specifically, these figures show exemplary access frequencies for the HDD 101-01 and the HDD 101-02. In this example, the DCAV volume 111 has access to two HDDs 101-01 and 101-02. In this example, if the access frequency at the two HDDs is within a range of A to B, the chunk move program 164 does nothing. However if the access frequency at the two HDDs is below or above the range A to B, the chunk move program 164 moves some chunks that are accessed at a higher frequency in one HDD to the other HDD that is not being accessed as frequently. For example, in FIG. 9(a) access frequency to both HDDs falls within the range A to B. In FIG. 9(b), the access frequency to HDD101-01 exceeds the range while access frequency to HDD 101-02 falls below the range. As a result, the chunk move program moves chunks from the low frequency HDD 101-02 to the chunk pool 110 while moving chunks allocated to the chunk pool by the high frequency HDD 101-01 back to this HDD. To determine the frequency of access to each HDD, the chunk table 169 shown in FIG. 4(b) is used. The chunk table 169 can store last five access times and WWN of the host computers that requested such access for each chunk number and its corresponding HDD.

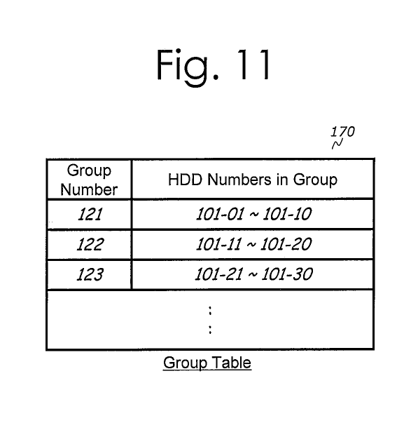

FIG. 10 illustrates a system with an exemplary grouping of the HDDs in a storage apparatus, according to aspects of the present invention. Specifically, FIG. 10 shows a variation of the storage apparatus 100 shown in FIG. 1(a). In FIG. 10, the HDDs are grouped into three groups of 121, 122 and 123. A group table 170 shown in FIG. 11 is used for grouping the HDDs. For the embodiment shown in FIG. 10, the chunk allocation rule table 167d shown in FIG. 5(d) is used. According to the chunk allocation rule table 167d, for segments 0 to 99999 in the volume, chunks should be provided from HDDs in the group 121. For the segments 100000 to 199999 in the volume, chunks should be provided from HDDs in the group 122.

If the storage apparatus includes several types of HDDs, for example, 15000 rpm HDD, 10000 rpm HDD, 7200 rpm HDD, and the like, the HDDs may be grouped by the type, rpm speed or any other kind of performance characteristic. In this case, changing the group would mean changing the performance. As FIG. 5(a) through FIG. 5(e) show, several chunk allocation rule tables are prepared according to the HDD type and one of the chunk allocation rule tables is assigned to the volume. If the chunk allocation rule table assigned to a volume is changed, performance of the volume also changes.

FIG. 11 illustrates an exemplary embodiment of a group table showing an exemplary grouping of the HDDs, according to aspects of the present invention. Specifically, FIG. 11 shows the group table 170 that is used in conjunction with the grouping of HDDs in FIG. 10. The group table 170 includes a column showing the group numbers 121, 122, 123 and another column showing the HDDs in each group. For example, group 121 includes HDD 101-01 to 101-10; group 122 includes HDD 101-11 to 101-20; and group 123 includes HDD 101-21 to 101-30.

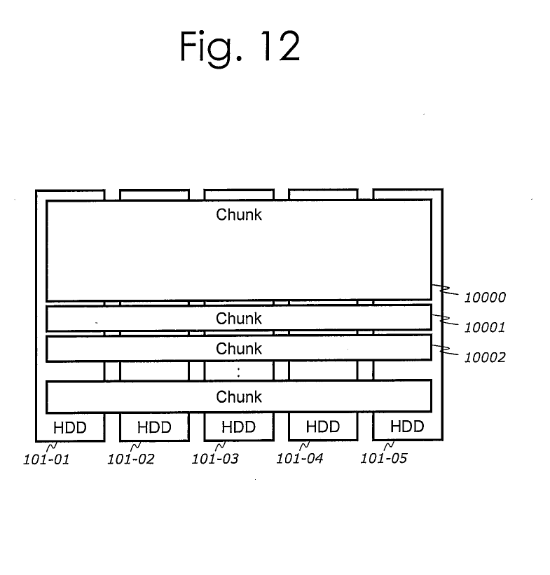

FIG. 12 illustrates exemplary chunks in a RAID group when an HDD is replaced by a RAID group, according to aspects of the present invention. An HDD can be replaced by a Redundant Array of Independent Disks (RAID) group. The RAID group incorporates a number of HDDs jointed using a RAID algorithm well known to persons of ordinary skill in the art. The RAID algorithm is implemented in the storage controller 150. FIG. 12 shows chunks in the RAID group. The chunk pool management table shown in FIG. 3(b) is used at the RAID configuration.

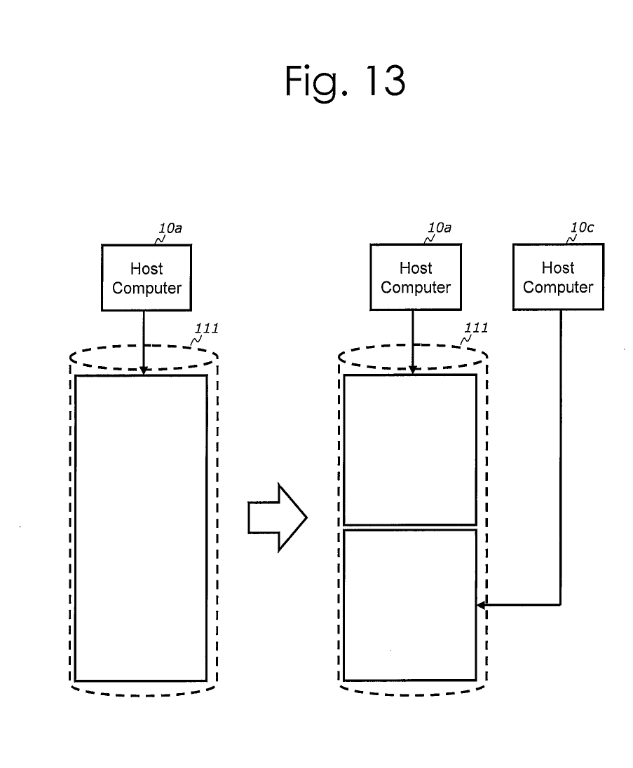

FIG. 13 illustrates an exemplary simultaneous access by two host computers to one volume, according to aspects of the invention. In accordance with an aspect of the invention, an administrator managing the computer system of FIG. 1(a) can change the host computer configuration. Host computer configuration change is described with respect to FIG. 13. In the example shown, the host computer 10a is assigned tasks, which access the first half data area of the volume 111. Then, the host computer 10c is initialized and assigned tasks, which access the last half data area of the volume 111. Thus, these two host computers access the volume 111 simultaneously as shown FIG. 13. The host computers 10a and 10c have different world wide names (WWN). Thus, the host ID identifying program 165 in the storage controller 150 can identify which host computer is issuing a command. The WWNs are stored in the chunk table 169b shown in FIG. 4(b).

The storage controller 150 may include the rule creation program 180 for creating and updating the chunk allocation rule table 167 in the storage apparatus 100 periodically. FIG. 5(e) is one example of the chunk allocation rule table which is created by the rule creation program 180. The rule creation program 180 creates the rule allocation rule table from the chunk table shown in FIG. 4(b) by scanning the “last five access time and WWN” column 16905. Segments of the volume that are being accessed by the host computer 10a are assigned to the HDD group 121. Segments of the volume 111 that are being accessed by the host computer 10c are assigned to the HDD group 122. Adapting the rule, eventually, segments accessed from the host computer 10a are allocated to the group 121 and segments accessed from the host computer 10c are allocated to the group 122 by the chunk move program 164. Performance of the volume 111 is increased due to increasing the number of HDDs allocated to the volume 111.

Once the host computer 10c has stopped, the task on the host computer 10c is consolidated on the host computer 10a. As a result, the host computer 10a gains access to all of the volume 111. In this case, the WWN stored in the “last five access time and WWN” of table 169b of FIG. 4(b) become the WWN of the host computer 10a. Also, chunks that have not been accessed for a predefined period of time in the group 122 should be moved to the HDDs in the group 121. Eventually, all segments in the volume 111 are allocated from the HDD group 121. Chunks previously allocated from the HDD group 122 are freed. If the HDDs in group 122 include no allocated chunks, the HDDs may be spun-down for reducing electric power consumption.

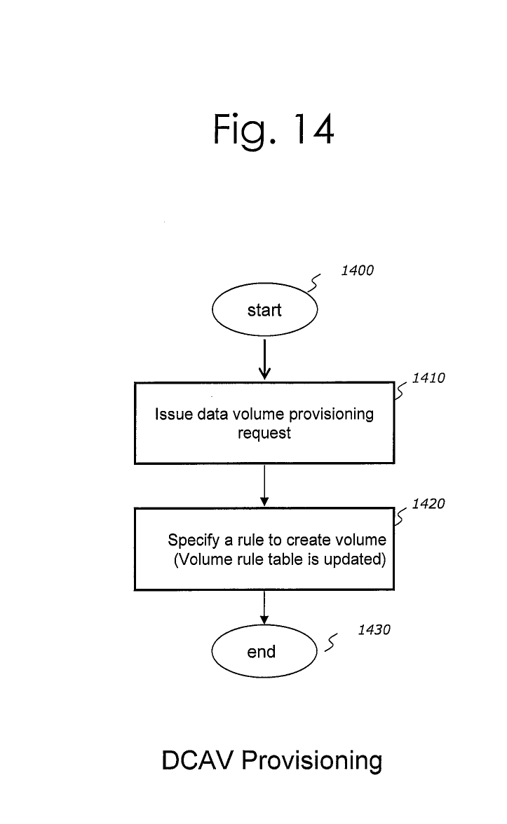

FIG. 14 shows a flow chart for an exemplary DCAV provisioning process, according to aspects of the invention. During an exemplary DCAV provisioning process, the host computer 10a requests a volume from the data volume provisioning request program 521 on the management computer 500 via the management network 90. Alternatively, an administrator on the management computer 500 may request a volume provisioning from the data volume provisioning request program 521. The DCAV provisioning process is explained with respect to FIG. 14 and FIG. 15.

At 1400, DCAV provisioning begins. At 1410, the data volume provisioning request program 521 issues a data volume provisioning request to the volume allocation program 162 on the storage controller 150. At 1420, the data volume provisioning request program 521 uses the volume rule mapping table 171 of FIG. 15 to specify a rule by importing one of the chunk allocation rule tables 167a, 167b, 167c, 167d, 167e to the volume created at 1410. At the same 1420, the volume rule mapping table 171 shown in FIG. 15 is updated. At 1430, the DCAV provisioning process ends.

A newly created volume does not initially have any chunks allocated to it because the volume is a dynamic chunk allocation volume DCAV. The host computers 10a-10c can obtain capacity information for any particular DCAV from the storage apparatus 100. In response to a READ CAPACITY command from the host computer, the response program 161 sends the capacity information of a DCAV to the host computer even if the DCAV has no allocated chunk. As a result, the host computer becomes aware that there is a volume dynamically allocated with a specific size in the storage apparatus 100.

FIG. 15 illustrates an exemplary embodiment of a volume rule mapping table to be used with a DCAV provisioning process, according to aspects of the invention. The rule table that applies to any specific volume is determined from the volume rule mapping table 171 shown in FIG. 15. An exemplary volume rule mapping table 171 (see FIG. 1(a)) is shown in FIG. 15. The volume rule mapping table 171 stores relationship between the rule table number 167a, 167b, etc. of the chunk allocation rule table 167 and volume number of the DCAV 111, 112. The volume rule mapping table 171 may also store the host computer number 10a, 10b or WWN of the host computer. In the embodiment shown, the host computer numbers 10a, 10b shown in the figure are used instead of the WWN.

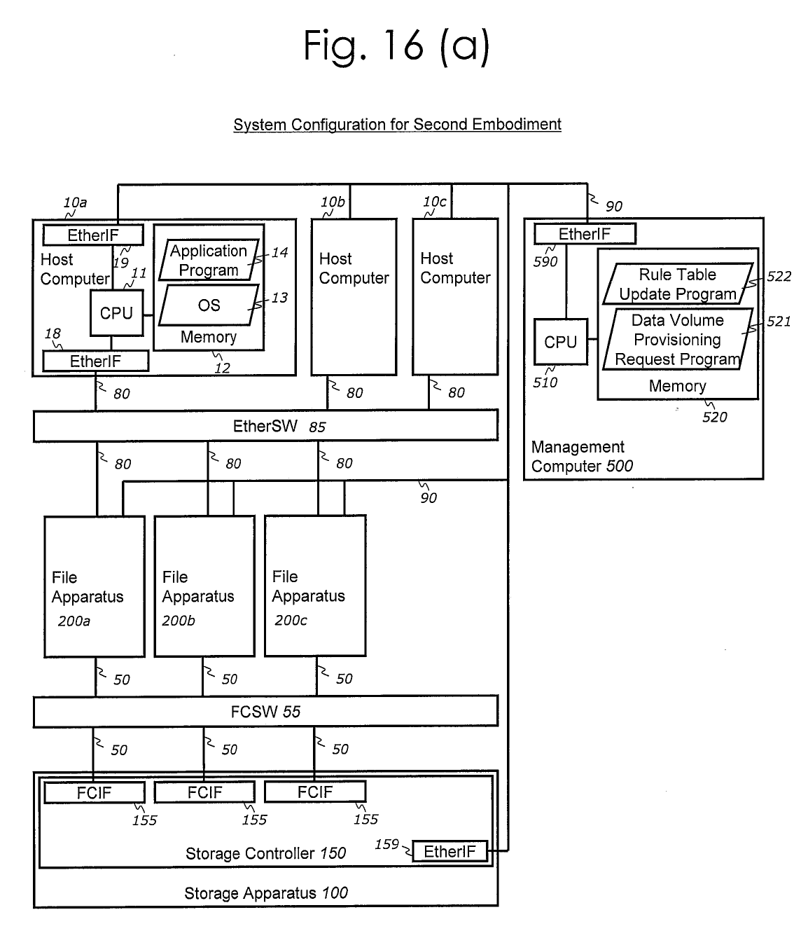

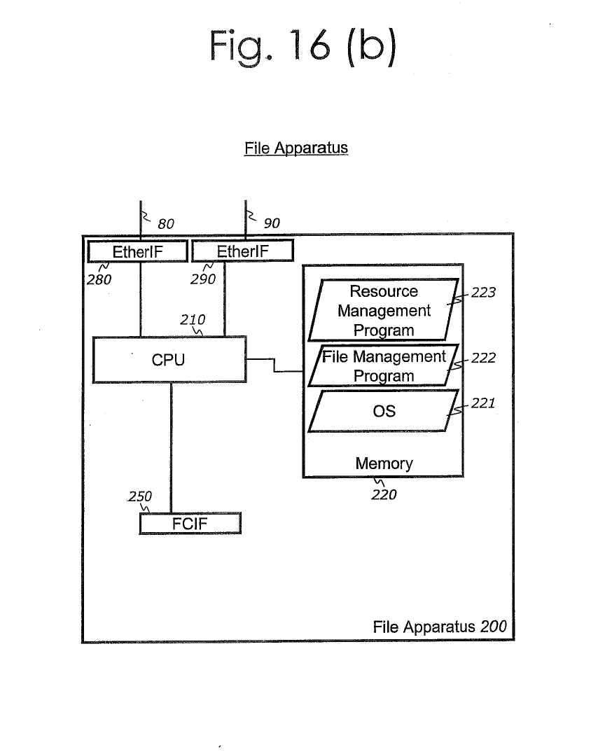

FIG. 16(a) and FIG. 16(b) show an exemplary information system for implementing methods according to other aspects of the present invention. Specifically, system configuration for a second embodiment is shown in the aforesaid FIG. 16(a) and FIG. 16(b). The differences between the first embodiments shown in FIG. 1(a) and FIG. 1(b) and the second embodiment are described below.

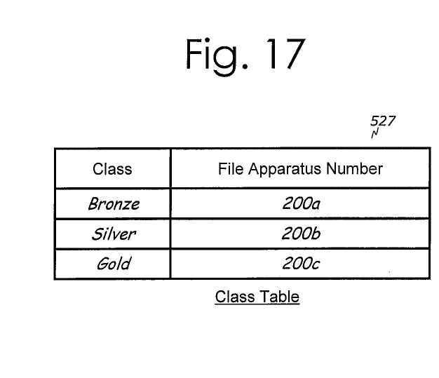

In this aspect of the invention, the host computer 10 is coupled to the storage apparatus 100 via the file apparatus 200. In the exemplary drawing shown, three file apparatus 200a, 200b and 200c are coupled to the storage apparatus 100. The file apparatus 200 is coupled to the management network 90. Instead of FCIF 15, the host computer 10 has EtherIF 18 for coupling to the file apparatus 200. Ethernet data network 80 and the Ethernet switch 85 are used for coupling the host computers to the file apparatuses. The file apparatus 200 is classified by its performance. Performance indicators include CPU clock, number of CPU cores, amount of memory, number of FCIF, number of EtherIF, and the like. A class table 527 shown in FIG. 17 is used to assign a class to each of the file apparatuses.

FIG. 16(b) includes details of the file apparatus 200. An exemplary file apparatus 200 includes a CPU 210 for executing programs stored in memory 220, a memory 220 for storing the programs and data, a FCIF 250 for coupling the file apparatus to the data network 50, an EtherIF 280 for coupling the file apparatus to the data network 80, and an EtherIF 290 for coupling the file apparatus to the management network 90.

At least three programs are stored in the memory 220 and executed by CPU 210 of the file apparatus 200. These programs include an operating system program (OS) 221, a file management program 222 for providing files in the volume to the host computers and a resource management program 223. In general, the file management program 222 includes file system function and the resource management program 223 is for allocating the resources of the file storage apparatus 200, such as CPU, memory, MAC address, IP address, WWN, and the like, to the file management program.

FIG. 17 shows an exemplary classification or class table, according to aspects of the present invention. The class table 527 of FIG. 17 is used for classifying the file apparatuses that are part of the second embodiment shown in FIG. 16(a). In the exemplary table shown, the file apparatus 200a is classified as “Bronze”, the file apparatus 200b is classified as “Silver”, and the file apparatus 200c is classified as “Gold.” In an embodiment of the invention, this table is stored on the management computer 500 shown in FIG. 16(a).

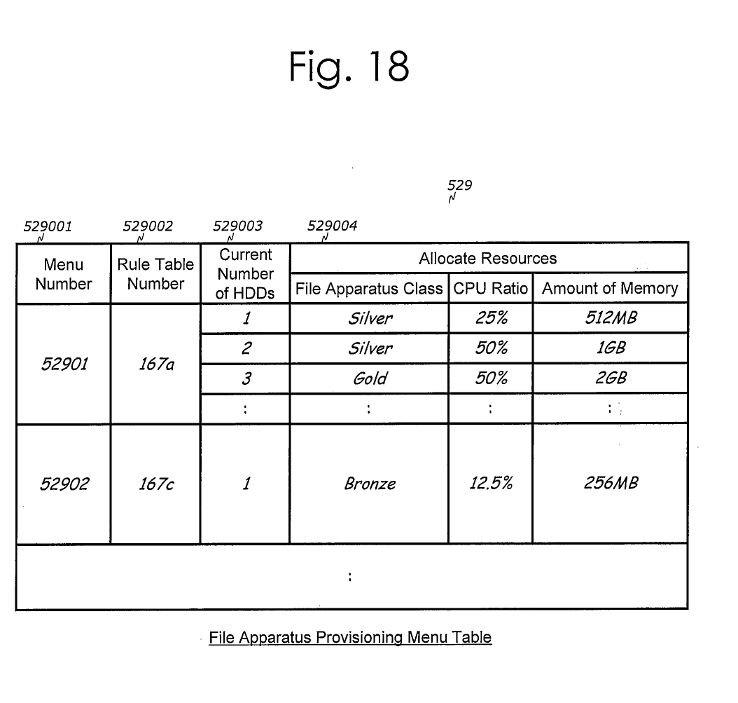

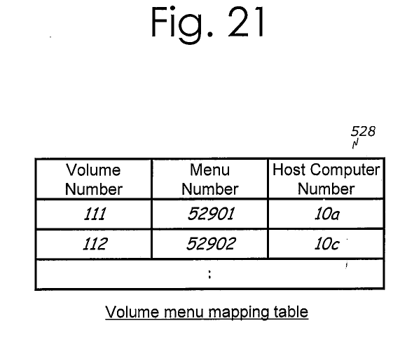

FIG. 18 shows an exemplary file apparatus provisioning menu table, according to aspects of the present invention. The file apparatus provisioning menu table 529 of FIG. 18 is to be considered together with the volume menu mapping table 528 shown in FIG. 21. The volume menu mapping table is used for allocating a volume to the host computer via the file apparatus and providing the menu number according to which HDDs are allocated to the volume.

The file apparatus provisioning menu table 529 includes a “Menu Number” column 529001 for storing the menu number of the menus, a “Rule Table Number” column 529002 for storing the number of the rule table used for a volume, a “Current Number of HDDs” column 529003 for storing number of HDDs currently being used by the volumes and corresponding to the resources, an “Allocate Resources” column 529004 for storing resources corresponding to the menu number and the current number of HDDs. In this embodiment, “File Apparatus Class”, “CPU ratio” and “Amount of Memory” are includes as types of resources that are subject to allocation.

The file apparatus provisioning menu table 529 is stored in the management computer 500.

The storage apparatus 100 in this embodiment issues an indication to the management computer 500 for notifying the management computer of the change in the number of HDDs that can be used by the volume. When the management computer 500 receives the indication from the storage apparatus via the management network 90, the management computer 500 reallocates appropriate resources or reprovisions the file management program 222 on appropriate file apparatus 200.

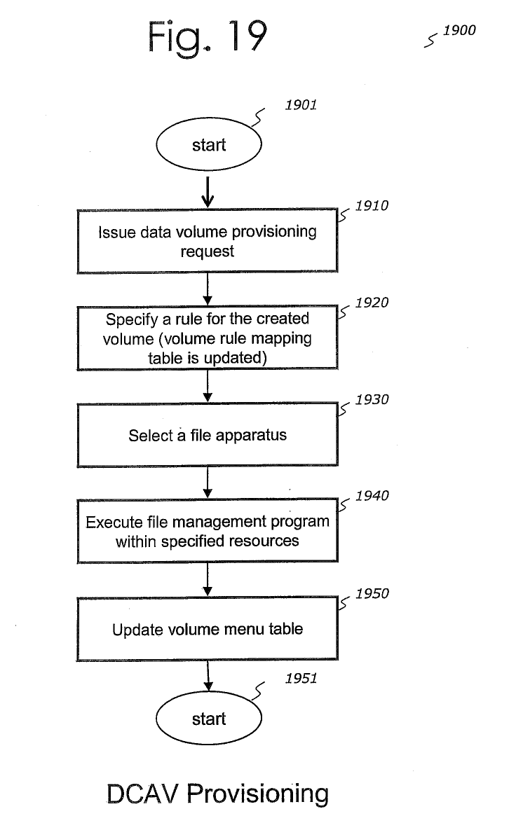

FIG. 19 shows a flowchart for an exemplary DCAV provisioning process, according to aspects of the present invention. The host computer 10a requests a volume provision with menu number to the data volume provisioning request program 521 on the management computer 500 via the management network 90. An administrator on the management computer 500 may request a volume provision with menu number to the data volume provisioning request program 521. The menu number is stored in the volume menu mapping table 528 shown in FIG. 21. New DCAV provisioning process 1900 is explained with respect to FIG. 19.

The process beings at 1901. At 1910, the data volume provisioning request program 521 issues a data volume provisioning request to the volume allocation program 162 on the storage controller 150. At 1920, the data volume provisioning request program 521 specifies a rule table number that is related to the menu number for the volume created in step 1910. At 1920, the volume rule mapping table of FIG. 15 is updated. The menu number for each volume is available from the volume menu mapping table 528 in FIG. 21.

At 1930, the data volume provisioning request program 521 selects a file apparatus which fits to the menu number and current number of HDDs. The data volume provisioning request program 521 checks if the file apparatus has sufficient resources. If any of the file apparatuses do not have sufficient resources in the specified class, a provisioning error has occurred and a message to that effect is sent to the requester. At 1940, the data volume provisioning request program 521 requests to execute the file management program within the resources specified by the selected file apparatus in step 1930. At 1950, the data volume provisioning request program 521 updates the volume menu mapping table 528.

At 1951 the process ends.

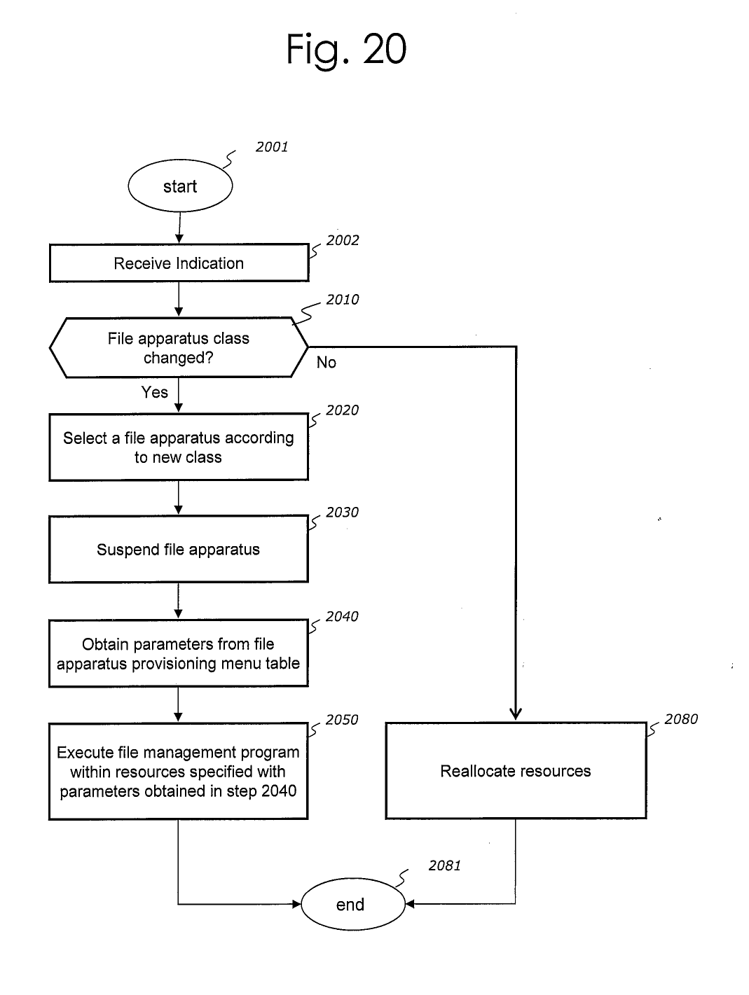

FIG. 20 shows a flowchart for an exemplary process of responding to an indication of change in the number of HDDs, according to aspects of the present invention. The management computer 500 receives an indication from the storage apparatus 100 when the number of HDDs that can be used is changed whether the number is increased or decreased. The indication includes the volume number and the rule table number.

The process 2000 followed by the management computer after receiving the indication of change of the number of HDDs begins at 2001. At 2002, the indication is received. At 2010, the data volume provisioning request program 521 determines whether the file apparatus class corresponding to the rule number and current number of HDDs is changed or not. The file apparatus class of each file apparatus is listed in class table 527 of FIG. 17 and again in the file apparatus provisioning menu table 529 of FIG. 18. If the file apparatus class has not changed, the process proceeds to step 2080. At 2080, the resources are reallocated and the process ends at 2081.

If the file apparatus class has changed, the process moves to 2020. At 2020, the data volume provisioning request program 521 selects a file apparatus which fits the new class. At 2030, the data volume provisioning request program 521 suspends the file management program 222. If cached data is stored in the memory 220, the data must be flushed to the volume or the data must be transferred to the new file apparatus selected in step 2020 before the suspension of the file apparatus. Then, at 2040, the data volume provisioning request program 521 obtains some parameters, such as IP address, MAC address, user IDs, user password, read/write/open/close status, WWN at a virtual machine configuration, and the like, from the resource management program 223. These parameters are required to resume the file management program on the new file apparatus. At 2050, the data volume provisioning request program 521 requests to execute the file management program on the new file apparatus selected in step 2020. The file management program is executed within the resources specified by the file apparatus provisioning menu table 529 of FIG. 18. The parameters obtained in step 2040 are also provided to the file management program 222. At 2081, the process ends.

FIG. 21 shows an exemplary volume menu mapping table 528, according to aspects of the present invention. The volume menu mapping table 528 stores relationship between the menu number and volume number so that the management computer understands what menu number is specified for each volume. The volume menu mapping table 528 may store the host computer number also. IP address or MAC address of each host computer 10 may be stored. In an embodiment of the inventive system, this table is stored on the management computer 500 shown in FIG. 16(a).

Administrators may change the menu number allocated to the volume and/or the rule table number in the file apparatus provisioning menu table 529 of FIG. 18 if needed. The data volume provisioning request program 521 updates the volume rule mapping table 171 of FIG. 15 in the storage controller 150 according to the changes made to table 529. Chunk allocation in the volume is adjusted according to the new rule.

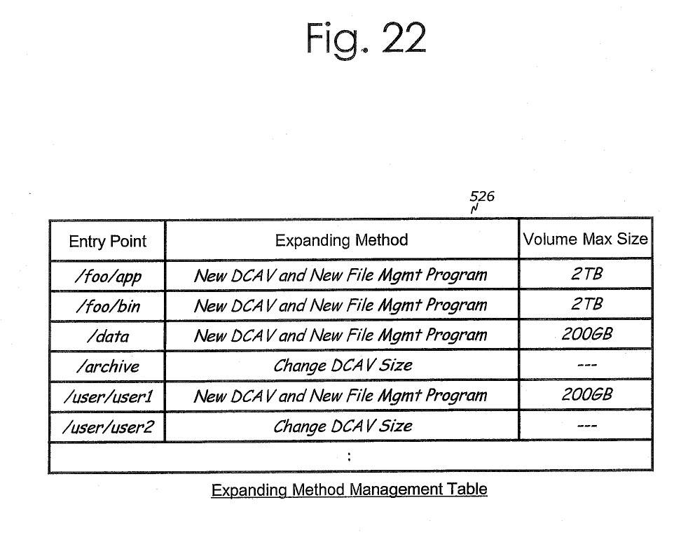

FIG. 22 shows an exemplary expanding method management table, according to aspects of the present invention. When a DCAV is full, the size of the DCAV may be changed to expand or a new DCAV and a new file management program may be allocated. To select one of these two methods, further described below, the management computer 500 may use an expanding method management table 526 shown in FIG. 22. The expanding method management table stores the expanding method for each entry point. FIG. 22 shows an example of the expanding method management table 526.

According to the first method, DCAV size needs to be changed when DCAV is full. In the case of reaching the full capacity at a volume, the data volume provisioning request program 521 may issue DCAV size change request to the dynamic chunk allocation program 160. The dynamic chunk allocation program 160 receives the DCAV size change request and the size of DCAV is changed. Physical size of the DCAV is not changed at this time, however. The file management program 222 may require file system reinitialization. In that case, the data volume provisioning request program 521 must issue the file system expansion request to the file management program 222.

According to the second method, new DCAV and new file management program is allocated when DCAV is full. In the case of reaching the full capacity at a volume, the data volume provisioning request program 521 may create another DCAV volume and allocate another file management program. Then, the data volume provisioning request program 521 connects the new volume to the host computer. Accesses to new files stored in the new volume are forwarded by the parent file management program or a centralized file management computer which manages all entry points of the file management program. In the case of applying the centralized file management computer, the host computers must inquire the entry point information which indicates location of desired file first, then access to the desired file with the entry point information. This table is stored on the management computer 500 shown in FIG. 16(a).

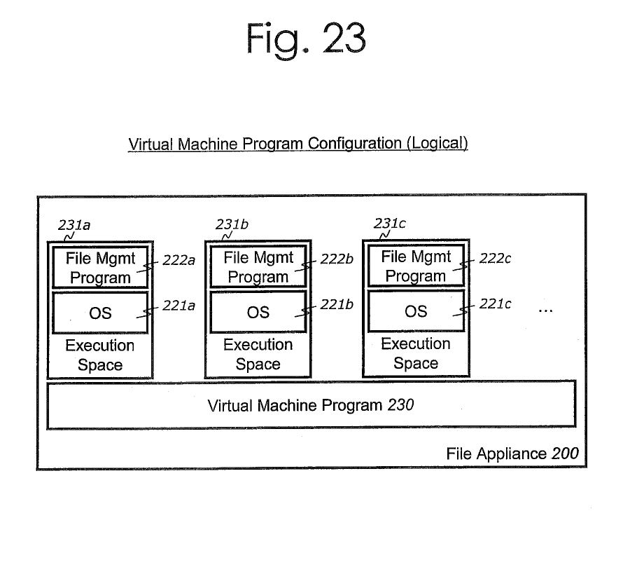

FIG. 23 shows an exemplary virtual machine configuration, according to aspects of the invention. In a variation of the aspects shown in FIG. 16(a) and FIG. 16(b), the file apparatus 200 may include a virtual machine program 230. The virtual machine program is stored in the memory 220 and executed on the CPU 210. FIG. 23 shows logical layer of the programs on the file apparatus 200v. The virtual machine program 230 has capabilities for managing resources. This capability is similar to the capabilities of the resource management program 223 of FIG. 16(b). The virtual machine 230 provides several execution spaces 231. In FIG. 23, the execution spaces 231a, 231b and 231c are provided. OS 221 and the file management program 222 are executed on each execution space. Appropriate resources are allocated by the virtual machine program 230 to each execution space.

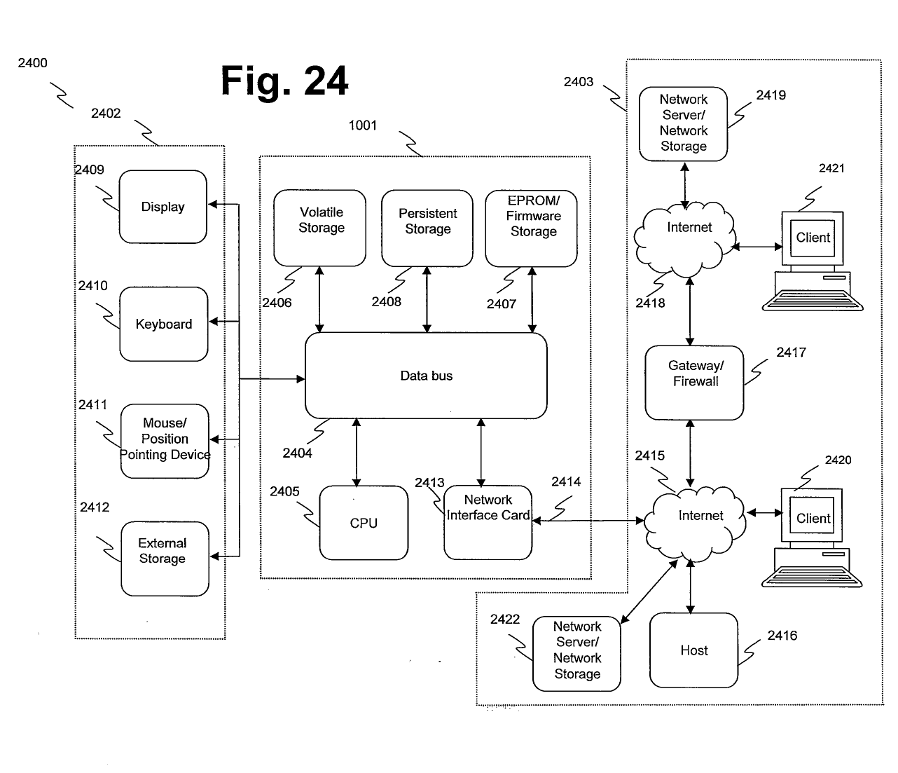

FIG. 24 is a block diagram that illustrates an embodiment of a computer/server system 2400 upon which an embodiment of the inventive methodology may be implemented. The system 2400 includes a computer/server platform 2401, peripheral devices 2402 and network resources 2403.

The computer platform 2401 may include a data bus 2404 or other communication mechanism for communicating information across and among various parts of the computer platform 2401, and a processor 2405 coupled with bus 2401 for processing information and performing other computational and control tasks. Computer platform 2401 also includes a volatile storage 2406, such as a random access memory (RAM) or other dynamic storage device, coupled to bus 2404 for storing various information as well as instructions to be executed by processor 2405. The volatile storage 2406 also may be used for storing temporary variables or other intermediate information during execution of instructions by processor 2405. Computer platform 2401 may further include a read only memory (ROM or EPROM) 2407 or other static storage device coupled to bus 2404 for storing static information and instructions for processor 2405, such as basic input-output system (BIOS), as well as various system configuration parameters. A persistent storage device 2408, such as a magnetic disk, optical disk, or solid-state flash memory device is provided and coupled to bus 2401 for storing information and instructions.

Computer platform 2401 may be coupled via bus 2404 to a display 2409, such as a cathode ray tube (CRT), plasma display, or a liquid crystal display (LCD), for displaying information to a system administrator or user of the computer platform 2401. An input device 2410, including alphanumeric and other keys, is coupled to bus 2401 for communicating information and command selections to processor 2405. Another type of user input device is cursor control device 2411, such as a mouse, a trackball, or cursor direction keys for communicating direction information and command selections to processor 2404 and for controlling cursor movement on display 2409. This input device typically has two degrees of freedom in two axes, a first axis (e.g., x) and a second axis (e.g., y), that allows the device to specify positions in a plane.

An external storage device 2412 may be coupled to the computer platform 2401 via bus 2404 to provide an extra or removable storage capacity for the computer platform 2401. In an embodiment of the computer system 2400, the external removable storage device 2412 may be used to facilitate exchange of data with other computer systems.

The invention is related to the use of computer system 2400 for implementing the techniques described herein. In an embodiment, the inventive system may reside on a machine such as computer platform 2401. According to one embodiment of the invention, the techniques described herein are performed by computer system 2400 in response to processor 2405 executing one or more sequences of one or more instructions contained in the volatile memory 2406. Such instructions may be read into volatile memory 2406 from another computer-readable medium, such as persistent storage device 2408. Execution of the sequences of instructions contained in the volatile memory 2406 causes processor 2405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 2405 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 2408. Volatile media includes dynamic memory, such as volatile storage 2406. Transmission media includes coaxial cables, copper wire and fiber optics, including the wires that comprise data bus 2404. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 2405 for execution. For example, the instructions may initially be carried on a magnetic disk from a remote computer. Alternatively, a remote computer can load the instructions into its dynamic memory and send the instructions over a telephone line using a modem. A modem local to computer system 2400 can receive the data on the telephone line and use an infra-red transmitter to convert the data to an infra-red signal. An infra-red detector can receive the data carried in the infra-red signal and appropriate circuitry can place the data on the data bus 2404. The bus 2404 carries the data to the volatile storage 2406, from which processor 2405 retrieves and executes the instructions. The instructions received by the volatile memory 2406 may optionally be stored on persistent storage device 2408 either before or after execution by processor 2405. The instructions may also be downloaded into the computer platform 2401 via Internet using a variety of network data communication protocols well known in the art.

The computer platform 2401 also includes a communication interface, such as network interface card 2413 coupled to the data bus 2404. Communication interface 2413 provides a two-way data communication coupling to a network link 2414 that is coupled to a local network 2415. For example, communication interface 2413 may be an integrated services digital network (ISDN) card or a modem to provide a data communication connection to a corresponding type of telephone line. As another example, communication interface 2413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 2413 sends and receives electrical, electromagnetic or optical signals that carry digital data streams representing various types of information.

Network link 2413 typically provides data communication through one or more networks to other network resources. For example, network link 2414 may provide a connection through local network 2415 to a host computer 2416, or a network storage/server 2417. Additionally or alternatively, the network link 2413 may connect through gateway/firewall 2417 to the wide-area or global network 2418, such as an Internet. Thus, the computer platform 2401 can access network resources located anywhere on the Internet 2418, such as a remote network storage/server 2419. On the other hand, the computer platform 2401 may also be accessed by clients located anywhere on the local area network 2415 and/or the Internet 2418. The network clients 2420 and 2421 may themselves be implemented based on the computer platform similar to the platform 2401.

Local network 2415 and the Internet 2418 both use electrical, electromagnetic or optical signals that carry digital data streams. The signals through the various networks and the signals on network link 2414 and through communication interface 2413, which carry the digital data to and from computer platform 2401, are exemplary forms of carrier waves transporting the information.

Computer platform 2401 can send messages and receive data, including program code, through the variety of network(s) including Internet 2418 and LAN 2415, network link 2414 and communication interface 2413. In the Internet example, when the system 2401 acts as a network server, it might transmit a requested code or data for an application program running on client(s) 2420 and/or 2421 through Internet 2418, gateway/firewall 2417, local area network 2415 and communication interface 2413. Similarly, it may receive code from other network resources.

The received code may be executed by processor 2405 as it is received, and/or stored in persistent or volatile storage devices 2408 and 2406, respectively, or other non-volatile storage for later execution. In this manner, computer system 2401 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized systems with functionality for allocating performance to data volumes on data storage systems and controlling performance of data volumes. It is intended that the specification and examples be considered as exemplary only, with a true scope and spirit of the invention being indicated by the following claims and their equivalents.

What is claimed is:

1. A computerized storage apparatus comprising:
a. a plurality of storage devices, the storage devices providing a plurality of storage chunks forming a chunk pool; and
b. a storage controller operable to dynamically allocate at least one of the plurality of chunks from the chunk pool to a storage volume in response to an access command received by the computerized storage apparatus, the access command being directed to the storage volume, wherein the storage controller is further operable to control a performance of the storage volume by controlling a number of the plurality storage devices furnishing the at least one of the plurality of chunks allocated to a storage volume in accordance with a predetermined rule associated with the storage volume.

2. The computerized storage apparatus of claim 1, further comprising a network interface operable to couple the computerized storage apparatus with a host computer, wherein the storage volume is associated with the host computer.

3. The computerized storage apparatus of claim 2, wherein the storage volume is exclusively used by the host computer.

4. The computerized storage apparatus of claim 1, wherein the storage controller is further operable to perform balancing of the at least one of the plurality of chunks allocated to a storage volume among the number of the storage devices allocated to the storage volume.

5. The computerized storage apparatus of claim 4, wherein the storage controller is operable to perform balancing in background.

6. The computerized storage apparatus of claim 1, wherein the predetermined rule provides for allocating more storage devices to the storage volume as more chunks of the plurality of chunks are allocated to the storage volume.

7. The computerized storage apparatus of claim 6, wherein the predetermined rule further provides performing load balancing between the allocated storage devices.

8. The computerized storage apparatus of claim 1, wherein the storage controller comprises a network interface operable to couple the storage controller with a management computer, the management computer operable to update the predetermined rule.

9. The computerized storage apparatus of claim 1, wherein the plurality of storage devices are grouped into a plurality of groups and wherein each of the plurality of groups is associated with a different predetermined rule.

10. The computerized storage apparatus of claim 9, wherein the plurality of storage devices are grouped into a plurality of groups in accordance with performance.

11. The computerized storage apparatus of claim 10, wherein the storage controller is operable to change a performance of at least a portion of the storage volume by changing a group of the plurality of groups corresponding to the portion of the storage volume.

12. The computerized storage apparatus of claim 9, wherein the storage volume is used by a first and a second host computers and wherein a first portion of the storage volume used by the first host computers is allocated using chunks from the first of the plurality of groups and a second portion of the storage volume used by the second host computers is allocated using chunks from the second of the plurality of groups.

13. The computerized storage apparatus of claim 1, wherein the storage controller is operable to change a performance of the storage volume by changing the predetermined rule.

14. The computerized storage apparatus of claim 1, wherein the plurality of storage devices are grouped into a plurality of groups and wherein each of the plurality of groups is associated with a different segment of the storage volume.

15. The computerized storage apparatus of claim 1, wherein the storage controller comprises a storage location operable to store a number of and information identifying the storage devices allocated to each storage volume.

16. The computerized storage apparatus of claim 1, wherein upon allocation of additional chunks to the storage volume by the storage controller, the storage controller is operable to use the predetermined rule to determine whether additional storage devices should be allocated to the storage volume.

17. The computerized storage apparatus of claim 16, wherein if the storage controller determines that additional storage devices should be allocated to the storage volume, the storage controller is operable to perform load balancing between the allocated storage devices.

18. The computerized storage apparatus of claim 16, wherein the additional chunks are allocated to the storage volume in response to a write command directed to the storage volume.

19. The computerized storage apparatus of claim 1, wherein in response to a read command directed to the storage volume, the storage controller is operable to use the predetermined rule to determine whether additional storage devices should be allocated to the storage volume.

20. The computerized storage apparatus of claim 19, wherein if the storage controller determines that additional storage devices should be allocated to the storage volume, the storage controller is operable to perform load balancing between the allocated storage devices.

21. The computerized storage apparatus of claims 20, wherein the load balancing is performed in a background mode.

22. The computerized storage apparatus of claim 1, wherein the plurality of storage devices comprise at least one RAID group incorporating a plurality of hard disk drives coupled together in accordance with RAID protocol, wherein the RAID protocol is performed by the storage controller and wherein the plurality of chunks are formed in the at least one RAID group.

23. The computerized storage apparatus of claim 1, wherein the storage controller comprises a network interface operable to couple the storage controller with a management computer and a host, the host operable to issue a first volume provisioning request to the management computer, and wherein the management computer is operable to issue a second volume provisioning request to the storage controller and to specify the predetermined rule for the volume.

24. The computerized storage apparatus of claim 1, wherein the storage controller comprises a network interface operable to couple the storage controller with at least one file apparatus, wherein the storage volume is allocated to the host computer using the at least one file apparatus.

25. The computerized storage apparatus of claim 24, wherein the at least one file apparatus is classified in accordance with a file apparatus performance.

26. The computerized storage apparatus of claim 25, wherein the file apparatus performance is determined, at least in part, by an amount of resources available within the file apparatus.

27. The computerized storage apparatus of claim 26, wherein the resources comprise amount of memory, a central processing unit speed or a data interface throughput.

28. The computerized storage apparatus of claim 25, wherein the performance of the storage volume is additionally controlled by the file apparatus performance.

29. The computerized storage apparatus of claim 25, wherein the storage controller comprises a network interface operable to couple the storage controller with a management computer, the at least one file apparatus and a host, the host operable to issue a first volume provisioning request to the management computer, and wherein the management computer is operable to issue a second volume provisioning request to the storage controller; to specify the predetermined rule for the volume; to select a file apparatus and cause the selected file apparatus to allocate the amount of resources available within the file apparatus to the storage volume.

30. A computer-implemented method performed in a storage system comprising a plurality of storage devices, the storage devices providing a plurality of storage chunks forming a chunk pool; and a storage controller, the method comprising:
a. dynamically allocating at least one of the plurality of chunks from the chunk pool to a storage volume in response to an access command received by the computerized storage apparatus, the access command being directed to the storage volume;
b. controlling a performance of the storage volume by controlling a number of the plurality storage devices furnishing the at least one of the plurality of chunks allocated to a storage volume in accordance with a predetermined rule associated with the storage volume.

31. A computer-readable medium embodying a set of instructions, which, when executed by one or more processors, cause the one or more processors to perform a method in a storage system comprising a plurality of storage devices, the storage devices providing a plurality of storage chunks forming a chunk pool; and a storage controller, the method comprising:
a. dynamically allocating at least one of the plurality of chunks from the chunk pool to a storage volume in response to an access command received by the computerized storage apparatus, the access command being directed to the storage volume;
b. controlling a performance of the storage volume by controlling a number of the plurality storage devices furnishing the at least one of the plurality of chunks allocated to a storage volume in accordance with a predetermined rule associated with the storage volume.
